(19) United States
(12) Patent Application Publication
(10) Pub. No.: US 2024/0264519 A1
(43) Pub. Date: Aug. 8, 2024

(54) PROJECTION OPTICAL SYSTEM AND PROJECTION TYPE DISPLAY DEVICE

(71) Applicant: FUJIFILM Corporation, Tokyo (JP)

(72) Inventors: Yukiko NAGATOSHI, Saitama (JP); Masanao KAWANA, Saitama (JP)

(73) Assignee: FUJIFILM Corporation, Tokyo (JP)

(21) Appl. No.: 18/407,297

(22) Filed: Jan. 8, 2024

(30) Foreign Application Priority Data
Jan. 30, 2023 (JP) 2023-012146

(51) Int. Cl. G03B 21/28; G02B 13/16

(52) U.S. Cl. CPC G03B 21/28; G02B 13/16

(57) ABSTRACT

The projection optical system projects an image, which is displayed on a display surface of a display element on a reduction side, to a projection surface on a magnification side, does not include a reflecting surface having a power, and includes at least one optical path deflection surface, which deflects an optical path by 90 degrees, in the optical path. Assuming that a sum of thicknesses of all optical elements on an optical axis included in a range from a lens surface closest to the magnification side in the projection optical system to a lens surface closest to the reduction side in the projection optical system is ΣTHe, a height of a maximum effective ray on the display surface from the optical axis is Imax, and a focal length of the projection optical system is f, the projection optical system satisfies ΣTHe<70 mm and 1.7<Imax/|f|.

### CROSS-REFERENCE TO RELATED APPLICATIONS

This application claims priority from Japanese Patent Application No. 2023-012146, filed on Jan. 30, 2023, the entire disclosure of which is incorporated herein by reference.

### BACKGROUND

### Technical Field

The technique of the present disclosure relates to a projection optical system and a projection type display device.

### Related Art

The optical systems described in JP6939469B and JP2022-124901A below have been known as optical systems applicable to the projection type display device.

### SUMMARY

There is a demand for a projection optical system capable of projecting a large screen from the vicinity of a screen. In order to project a large screen, a bright projection type display device is necessary. In addition, there is a demand for a projection type display device that is configured to have a small size and have excellent portability so as to be able to perform projection at various places.

The present disclosure has been made in view of the above circumstances, and an object thereof is to provide a small-size projection optical system capable of projecting a bright and large projected image from the vicinity of a screen, and a projection type display device comprising the projection optical system.

According to an aspect of the present disclosure, there is provided a projection optical system that projects an image, which is displayed on a display surface of a display element on a reduction side, onto a projection surface on a magnification side. The projection optical system does not include a reflecting surface having a power, the projection optical system includes at least one optical path deflection surface, which deflects an optical path by 90 degrees, in the optical path of the projection optical system. Assuming that a sum of thicknesses of all optical elements on an optical axis included in a range from a lens surface closest to the magnification side in the projection optical system to a lens surface closest to the reduction side in the projection optical system is ΣTHe, a height of a maximum effective ray on the display surface from the optical axis is Imax, and a focal length of the projection optical system is f, where f is a value at a wide angle end in a case where the projection optical system is a variable magnification optical system, and mm is a unit of length, Conditional Expressions (1) and (2) are satisfied, which are represented by

$$\sum THe < 70 mm , and \qquad ( 1 )$$

$$1.7 < Imax / \vert f \vert . \qquad ( 2 )$$

It is preferable that the projection optical system according to the above-mentioned aspect satisfies at least one of Conditional Expression (1-1) or (2-1), which are represented by

$$30 mm < \sum THe < 70 mm , and \qquad ( 1 - 1 )$$

$$2 < Imax / \vert f \vert < 3.5 . \qquad ( 2 - 1 )$$

It is preferable that the projection optical system according to the above-mentioned aspect includes only two optical path deflection surfaces in the optical path of the projection optical system. Assuming that a distance on the optical axis from the optical path deflection surface on the magnification side to the optical path deflection surface on the reduction side is d1, and a distance on the optical axis from the optical path deflection surface on the reduction side to the lens surface closest to the reduction side in the projection optical system is d2, where d1 and d2 are values at the wide angle end in a case where the projection optical system is a variable magnification optical system, it is preferable that the projection optical system satisfies Conditional Expressions (3) and (4), which are represented by

$$d 1 < 70 mm , and \qquad ( 3 )$$

$$d 2 < 100 mm . \qquad ( 4 )$$

It is more preferable that the projection optical system according to the above-mentioned aspect satisfies Conditional Expressions (3) and (4) and then satisfies at least one of Conditional Expression (3-1) or (4-1), which are represented by

$$10 mm < d 1 < 50 mm , and \qquad ( 3 - 1 )$$

$$20 mm < d 2 < 75 mm . \qquad ( 4 - 1 )$$

Assuming that a longest diameter of a maximum region capable of display of the image in the display element is DL, it is preferable that the projection optical system according to the above-mentioned aspect satisfies Conditional Expression (5), which is represented by

$$I max / DL < 0 \text{.78} , \qquad ( 5 )$$

it is more preferable that the projection optical system satisfies Conditional Expression (5-1), which is represented by

$$0.65 < I max / DL < 0 \text{.72} . \qquad ( 5 - 1 )$$

Assuming that a height of a maximum effective ray on the projection surface from the optical axis is Ymax, and a paraxial image magnification of the projection optical system in a case where the magnification side is an object side and the reduction side is an image side is β, where β is a value at a wide angle end in a case where the projection optical system is a variable magnification optical system, it is preferable that the projection optical system according to the above-mentioned aspect satisfies Conditional Expression (6), which is represented by

$$- 0.05 < ( I max - β \times Y max ) / ( β \times Y max ) < 0 \text{.05} , \qquad ( 6 )$$

it is more preferable that the projection optical system satisfies Conditional Expression (6-1), which is represented by

$$- 0.03 < ( I max - β \times Y max ) / ( β \times Y max ) < 0 \text{.03} . \qquad ( 6 - 1 )$$

Assuming that a sum of thicknesses of all optical elements on the optical axis, which have powers and are included in the range from the lens surface closest to the magnification side in the projection optical system to the lens surface closest to the reduction side in the projection optical system, is ΣTHpw, and a sum of thicknesses of all optical elements, which have a refractive index of 1.8 or more at a d line, on the optical axis among the optical elements, which have the powers and are included in the range from the lens surface closest to the magnification side in the projection optical system to the lens surface closest to the reduction side in the projection optical system, is ΣTH18, it is preferable that the projection optical system according to the above-mentioned aspect satisfies Conditional Expression (7), which is represented by

$$0.27 < Σ TH 18 / Σ THpw < 0.5 , \qquad ( 7 )$$

it is more preferable that the projection optical system satisfies Conditional Expression (7-1), which is represented by

$$0.3 < Σ TH 18 / Σ THpw < 0.4 . \qquad ( 7 - 1 )$$

It is preferable that an intermediate image is formed on an inside of the projection optical system.

In the projection optical system according to the above-mentioned aspect, it is preferable that the projection optical system includes only two optical path deflection surfaces in the optical path of the projection optical system, and the intermediate image is formed on the optical path between the optical path deflection surface on the magnification side and a surface adjacent to the reduction side of the optical path deflection surface on the reduction side.

It is preferable that the projection optical system according to the above-mentioned aspect further comprises an aperture stop at a position closer to the reduction side than the intermediate image. A real image of the aperture stop is present on an inside of the projection optical system closer to the magnification side than the intermediate image. Assuming that a position, at which a ray that is emitted from an outermost circumference of an effective image circle on the reduction side and that has passed through a center of the aperture stop toward the magnification side intersects with the optical axis at a position closer to the magnification side than the intermediate image, is Enp(Imax), a position of a paraxial image of the aperture stop is Enp(0), and an air-equivalent distance on the optical axis from Enp(0) to Enp(Imax) is DifE, where a sign of DifE is positive in a case where the air-equivalent distance is a distance on the reduction side, and the sign is negative in a case where the air-equivalent distance is a distance on the magnification side, with reference to Enp(0), and where DifE is a value at a wide angle end in a case where the projection optical system is a variable magnification optical system, it is preferable that the projection optical system according to the above-mentioned aspect satisfies Conditional Expression (8), which is represented by

$$- 3 < DifE / I max < - 0.2 , \qquad ( 8 )$$

it is more preferable that the projection optical system satisfies Conditional Expression (8-1), which is represented by

$$- 2.5 < DifE / I max < - 0.5 . \qquad ( 8 - 1 )$$

A lens closest to the magnification side may be configured to have a shape in which a part of a rotationally symmetric shape is absent.

At least one of the optical path deflection surfaces may be configured to be a surface of a reflection mirror. At least one of the optical path deflection surfaces may be configured to be a surface of a prism.

According to another aspect of the present disclosure, there is provided a projection type display device comprising the projection optical system according to the above-mentioned aspect.

In the present specification, it should be noted that the term “consists of” means that the lens may include not only the above-mentioned components but also lenses substantially having no refractive powers, optical elements, which are not lenses, such as a stop, a mask, a filter, a cover glass, a plane mirror, and a prism, and mechanism parts such as a lens flange, a lens barrel, an imaging element, and a camera shaking correction mechanism.

A compound aspherical lens (in which a lens (for example, a spherical lens) and an aspherical film formed on the lens are integrally formed and function as one aspherical lens as a whole) is not regarded as cemented lenses, but the compound aspherical lens is regarded as one lens. The sign of the refractive power, and the surface shape of the lens including the aspherical surface will be used in terms of the paraxial region unless otherwise specified. Unless otherwise specified, the “distance on the optical axis” used in Conditional Expression is considered as a geometrical distance. The “focal length” used in a conditional expression is a paraxial focal length. The values used in conditional expressions are values in a case where the d line is set as a reference. The “mm” used in the conditional expressions is millimeters in a unit of a length.

The “d line”, “C line”, and “F line” described in the present specification are bright lines, the wavelength of the d line is 587.56 nm (nanometers), the wavelength of the C line is 656.27 nm (nanometers), and the wavelength of the F line is 486.13 nm (nanometers).

According to the present disclosure, it is possible to provide a small-size projection optical system capable of projecting a bright and large projected image from the vicinity of a screen, and a projection type display device comprising the projection optical system.

### BRIEF DESCRIPTION OF THE DRAWINGS

FIG. 1 is a cross-sectional view showing a configuration and luminous flux of a projection optical system according to an embodiment corresponding to a projection optical system of Example 1.

FIG. 2 is a diagram showing an example of Imax and DL.

FIG. 3 is a cross-sectional view of an optical path of the projection optical system of FIG. 1 in which the optical path of the projection optical system is developed and is a diagram showing Enp(0) and Enp(Imax).

FIG. 4 is a partially enlarged view of FIG. 3 and is a diagram showing DifE.

FIGS. 5A, 5B, and 5C are diagrams showing an example of a shape of a lens in which a part of a rotationally symmetric shape is absent.

FIG. 6 is a diagram of aberrations in the projection optical system of Example 1.

FIG. 7 is a cross-sectional view showing a configuration and luminous flux of a projection optical system of Example 2.

FIG. 8 is a diagram of aberrations in the projection optical system of Example 2.

FIG. 9 is a cross-sectional view showing a configuration and luminous flux of a projection optical system of Example 3.

FIG. 10 is a cross-sectional view showing a configuration and luminous flux in which the optical path of the projection optical system of FIG. 9 is developed.

FIG. 11 is a diagram of aberrations in the projection optical system of Example 3.

FIG. 12 is a cross-sectional view showing a configuration and luminous flux of a projection optical system of Example 4.

FIG. 13 is a diagram of aberrations in the projection optical system of Example 4.

FIG. 14 is a cross-sectional view showing a configuration and luminous flux of a projection optical system of Example 5.

FIG. 15 is a diagram of aberrations in the projection optical system of Example 5.

FIG. 16 is a cross-sectional view showing a configuration and luminous flux of a projection optical system of Example 6.

FIG. 17 is a diagram of aberrations in the projection optical system of Example 6.

FIG. 18 is a schematic configuration diagram of a projection type display device according to an embodiment.

FIG. 19 is a schematic configuration diagram of a projection type display device according to another embodiment.

FIG. 20 is a schematic configuration diagram of a projection type display device according to still another embodiment.

### DESCRIPTION OF EMBODIMENTS

Hereinafter, embodiments of the present disclosure will be described with reference to the accompanying drawings.

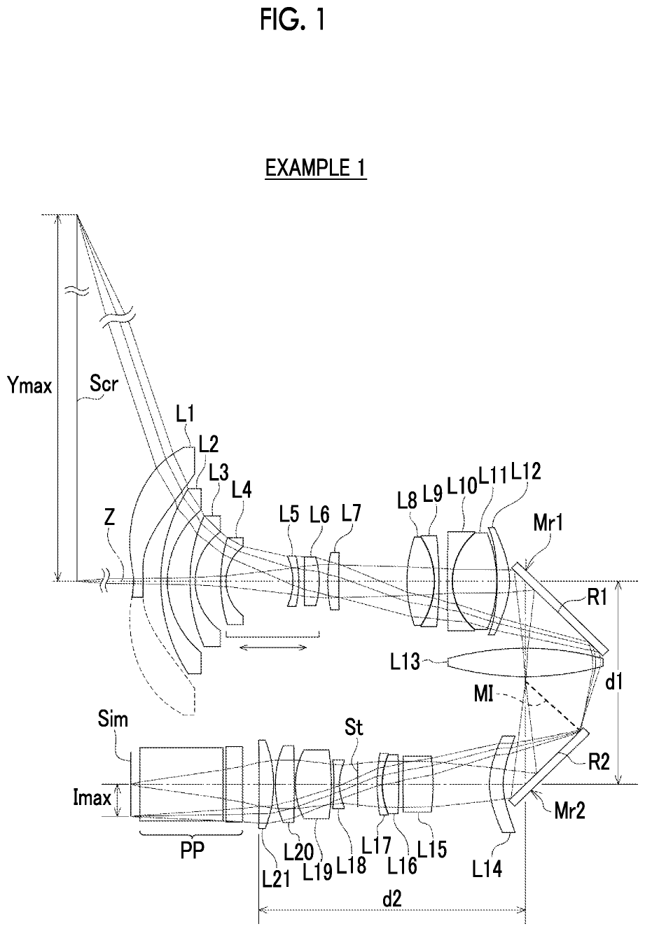

FIG. 1 shows a configuration of a projection optical system and a cross-sectional view of luminous flux according to an embodiment of the present disclosure. FIG. 1 shows, as the luminous flux, on-axis luminous flux and luminous flux with the maximum angle of view. The example shown in FIG. 1 corresponds to a projection optical system of Example 1 to be described later.

FIG. 1 shows an example in which an optical member PP and a display surface Sim of a light valve are disposed on the reduction side of the projection optical system on the assumption that the projection optical system is mounted on the projection type display device. The light valve is a display element which outputs an optical image, and the optical image is displayed as an image on the display surface Sim. As the light valve, for example, a liquid crystal display element or an image display element such as digital micromirror device (DMD: registered trademark) can be used. The optical member PP is a member which is regarded as a filter, a cover glass, a color synthesis prism, or the like. The optical member PP is a member that has no refractive power. The material, the length, and the number of components of the optical member PP can be appropriately changed. A configuration in which the optical member PP is omitted is also possible.

The projection optical system is, for example, mounted on a projection type display device and projects an image displayed on the display surface Sim of the display element on the reduction side onto a projection surface on the magnification side. In the projection type display device, luminous flux provided with image information on the display surface Sim is incident on the projection optical system through the optical member PP, and is projected onto the screen Scr which is the projection surface through the projection optical system. That is, the display surface Sim and the screen Scr are positioned at optically conjugate positions. The display surface Sim corresponds to the conjugate plane on the reduction side, and the screen Scr corresponds to the conjugate plane on the magnification side. It should be noted that, in the present specification, the term “screen Scr” means an object on which a projected image formed by the projection optical system is projected. The screen Scr may be not only a dedicated screen but also a wall surface of a room, a floor surface, a ceiling surface, an outer wall surface of a building, or the like.

In the description of the present specification, the term “magnification side” means the screen Scr side on the optical path, and the “reduction side” means the display surface Sim side on the optical path. In the present specification, the “magnification side” and the “reduction side” are determined along the optical path. Further, the term “adjacent” in the disposition of the constituent elements means that the constituent elements are adjacent to each other in the arrangement order on the optical path. In the following description, in order to avoid making the description redundant, the phrase “in order from the magnification side to the reduction side along the optical path” may be described as “in order from the magnification side to the reduction side”.

For example, the projection optical system of FIG. 1 includes, in order from the magnification side to the reduction side along the optical path, lenses L1 to L12, a reflection mirror Mr1, a lens L13, a reflection mirror Mr2, lenses L14 to L17, an aperture stop St, and lenses L18 to L21. The aperture stop St shown in FIG. 1 does not indicate the size and the shape, but indicates the position in the optical axis direction.

The reflection mirror Mr1 and the reflection mirror Mr2 are optical path deflecting members which deflect the optical path. The reflection mirror Mr1 has a planar reflecting surface R1. The reflection mirror Mr2 has a planar reflecting surface R2. The reflecting surface R1 and the reflecting surface R2 are surfaces which have no power. The optical path is deflected by 90 degrees in each of the reflecting surface R1 and the reflecting surface R2.

The projection optical system according to the present disclosure is configured not to include a reflecting surface which has a power. In a projection optical system including a reflecting surface having a power, in general, luminous flux near the optical axis reflected by the reflecting surface is blocked by the projection type display device and cannot be used to form a projected image. Therefore, in order to avoid the light blocking, a central position of the image of the display surface Sim is configured to be shifted from the optical axis Z of the projection optical system, and an amount of shift is usually increased. For this reason, in the projection optical system including the reflecting surface having a power, the size of the reflecting surface having a power tends to be large. As a result, it is difficult to achieve reduction in size thereof. In contrast, the projection optical system according to the present disclosure does not include the reflecting surface having a power. Therefore, the luminous flux near the optical axis can be used for forming the projected image. As a result, the amount of shift can be reduced even in a case where the shift is performed. By reducing the amount of shift, each optical element can be reduced in size. Therefore, the entire optical system can be led to reduction in size.

The projection optical system according to the present disclosure includes at least one optical path deflection surface which deflects the optical path by 90 degrees in the optical path of the projection optical system. The optical system can be made compact by deflecting the optical path. Thus, this configuration is able to contribute to size reduction. It should be noted that the term “90 degrees” includes an error that is practically allowed in the technical field to which the technique of the present disclosure belongs. The error can be, for example, in a range of −1 degree or more and +1 degree or less.

At least one of the optical path deflection surfaces may be a surface of the reflection mirror. In such a case, there is an advantage in achieving reduction in weight. The reflection mirror may be a metal mirror or a dielectric multi-layer film mirror. At least one of the optical path deflection surfaces may be a surface of a prism. In such a case, there is an advantage in ensuring performance during assembly. The surface of the prism on which a reflective film is formed may be used as the optical path deflection surface, or the surface of the prism may be used as the optical path deflection surface by using total reflection.

The projection optical system of the example of FIG. 1 includes two optical path deflection surfaces that deflect the optical path by 90 degrees. In the example of FIG. 1, the reflecting surface R1 and the reflecting surface R2 correspond to the optical path deflection surfaces.

In the projection optical system according to the present disclosure, it is preferable that the intermediate image MI is formed on the inside of the projection optical system. In a case where the focal length of the projection optical system is shortened to achieve an increase in angle of view, in order to achieve optical performance necessary for the projection optical system while ensuring the back focal length necessary for the projection optical system, the size of the lens on the magnification side tends to be increased. By using a relay optical system in which the intermediate image MI is formed, it is possible to shorten the back focal length of the optical system closer to the magnification side than the intermediate image MI, and to reduce the diameter of the lens on the magnification side. As a result, there is an advantage in achieving reduction in size.

In the example of FIG. 1, the intermediate image MI is formed between the lens L13 and the reflection mirror Mr2. The image on the display surface Sim, the intermediate image MI, and the projected image on the screen Scr have an optical conjugation relationship. It should be noted that, in FIG. 1, the intermediate image MI is conceptually indicated by the dotted line, and the shape of the intermediate image MI in FIG. 1 is not accurate.

It is preferable that, in a case where the projection optical system includes only two optical path deflection surfaces in the optical path thereof, the intermediate image MI is formed on the optical path between the optical path deflection surface on the magnification side and a surface adjacent to the reduction side of the optical path deflection surface on the reduction side. In such a case, there is an advantage in suppressing the size of the projection optical system in two directions perpendicular to each other. Here, the term “two directions perpendicular to each other” means, for example, the up-down direction and the left-right direction in FIG. 1.

Next, preferable and possible configurations about conditional expressions of the projection optical system according to the present disclosure will be described. In the following description of conditional expressions, in order to avoid redundant descriptions, the same symbols are used for those having the same definition, and duplicate descriptions of the symbols will not be repeated. Further, in the following description, in order to avoid redundant description, the “projection optical system according to the embodiment of the present disclosure” is also simply referred to as a “projection optical system”.

It is preferable that the projection optical system satisfies Conditional Expression (1). Here, it is assumed that a sum of thicknesses of all optical elements on an optical axis included in a range from a lens surface closest to the magnification side in the projection optical system to a lens surface closest to the reduction side in the projection optical system is ΣTHe. An optical element other than the lenses ranging from the lens surface closest to the magnification side in the projection optical system and the lens surface closest to the reduction side in the projection optical system, for example, a prism may be disposed therein. In such a case, the“all optical elements” described above also includes the prism. By not allowing the result of Conditional Expression (1) to be equal to or greater than the upper limit thereof, a transmittance of the material of the optical element of the projection optical system is prevented from becoming excessively low due to internal absorption. Therefore, it is easy to ensure the luminance of the optical engine. It is more preferable that the projection optical system according to the present disclosure satisfies Conditional Expression (1-1). By not allowing the result of Conditional Expression (1-1) to be equal to or less than the lower limit thereof, the thickness of each optical element is prevented from becoming excessively thin. Therefore, it is easy to perform aberration correction in an ultra-wide-angle optical system, particularly, correction of distortion and correction of field curvature.

$$Σ T H e < 70 mm \qquad ( 1 )$$

$$30 mm < Σ THe < 70 mm \qquad ( 1 - 1 )$$

It is preferable that the projection optical system satisfies Conditional Expression (2). Here, it is assumed that a height of the maximum effective ray on the display surface Sim from the optical axis Z is Imax. It is assumed that a focal length of the projection optical system is f. f is a value at the wide angle end in a case where the projection optical system is a variable magnification optical system. The effective ray is a ray used to form a projected image. The maximum effective ray is a ray farthest from the optical axis Z in the radial direction among the rays used for forming the projected image. In a case where the reduction side is set as the image side, the height Imax is a maximum image height of the projection optical system. By not allowing the result of Conditional Expression (2) to be equal to or less than the lower limit thereof, it is possible to project a large-screen projected image in a state where a distance between the projection optical system and the screen Scr is short. In order to obtain more favorable characteristics, it is more preferable that the projection optical system satisfies Conditional Expression (2-1). By not allowing the result of Conditional Expression (2-1) to be equal to or greater than the upper limit thereof, it is easy to achieve both reduction in size of the projection type display device and projection performance.

$$1.7 < I max / \vert f \vert \qquad ( 2 )$$

$$2 < I max / \vert f \vert < 3.5 \qquad ( 2 - 1 )$$

In a case where the projection optical system includes only two optical path deflection surfaces in the optical path thereof, it is preferable that the projection optical system satisfies Conditional Expression (3). Here, it is assumed that a distance on the optical axis from the optical path deflection surface on the magnification side to the optical path deflection surface on the reduction side is d1. The distance d1 is a value at the wide angle end in a case where the projection optical system is a variable magnification optical system. By not allowing the result of Conditional Expression (3) to be equal to or greater than the upper limit thereof, it is possible to suppress an increase in size of the projection optical system in the direction of the distance d1 (the up-down direction in FIG. 1). As a result, it is easy to achieve reduction in size. In a case where the direction of the distance d1 is the thickness direction of the projection type display device, there is an advantage in achieving reduction in thickness of the projection type display device. In order to obtain more favorable characteristics, it is more preferable that the projection optical system satisfies Conditional Expression (3-1). By not allowing the result of Conditional Expression (3-1) to be equal to or less than the lower limit thereof, it is possible to suppress interference between the projection type display device body and the projected image. Further, it is possible to suppress interference between the optical elements ranging from the optical element closest to the magnification side to the optical path deflection surface on the magnification side and an optical element ranging from the display element and the optical path deflection surface on the reduction side.

$$d 1 < 70 mm \qquad ( 3 )$$

$$10 mm < d 1 < 50 mm \qquad ( 3 - 1 )$$

In a case where the projection optical system includes only two optical path deflection surfaces in the optical path thereof, it is preferable that the projection optical system satisfies Conditional Expression (4). Here, it is assumed that a distance on the optical axis from the optical path deflection surface on the reduction side to the lens surface closest to the reduction side in the projection optical system is d2. The distance d2 is a value at the wide angle end in a case where the projection optical system is a variable magnification optical system. By not allowing the result of Conditional Expression (4) to be equal to or greater than the upper limit thereof, it is possible to suppress an increase in size of the projection optical system in the direction of the distance d2 (the left-right direction in FIG. 1). As a result, it is easy to achieve reduction in size. In a case where the direction of the distance d2 is set to be parallel to the mounting surface of the projection type display device, there is an advantage in further reducing the area necessary for mounting the projection type display device. In order to obtain more favorable characteristics, it is more preferable that the projection optical system satisfies Conditional Expression (4-1). By not allowing the result of Conditional Expression (4-1) to be equal to or less than the lower limit thereof, the total length of the optical system does not have to be extremely shortened. As a result, there is an advantage in correcting field curvature for achieving an increase in angle of view.

$$d 2 < 100 mm \qquad ( 4 )$$

$$20 mm < d 2 < 75 mm \qquad ( 4 - 1 )$$

In a case where the projection optical system includes only two optical path deflection surfaces in the optical path thereof, it is preferable that the projection optical system satisfies Conditional Expressions (3) and (4). By satisfying Conditional Expressions (3) and (4) in the projection optical system, it is possible to accelerate reduction in size of the projection type display device. Further, in order to further achieve reduction in size and further favorable characteristics, the projection optical system satisfies Conditional Expressions (3) and (4), and it is more preferable that the projection optical system satisfies at least one of Conditional Expression (3-1) or (4-1).

It is preferable that the projection optical system satisfies Conditional Expression (5). Here, it is assumed that a longest diameter of a maximum region capable of display of the image in the display element is DL. By not allowing the result of Conditional Expression (5) to be equal to or greater than the upper limit thereof, it is possible to suppress an increase in size of the entire optical system. In particular, it is possible to suppress an increase in size of the lens on the magnification side. As a result, it is easy to achieve reduction in size. In order to obtain more favorable characteristics, it is more preferable that the projection optical system satisfies Conditional Expression (5-1). By not allowing the result of Conditional Expression (5-1) to be equal to or less than the lower limit thereof, it is easy to prevent the projected image from being blocked by the projection type display device body.

$$I max / DL < 0 \text{.78} \qquad ( 5 )$$

$$0.65 < I max / DL < 0. 72 \qquad ( 5 - 1 )$$

The DL will be described below. In the following description of the DL, for convenience of description, the “maximum region capable of display of the image in the display element” will be referred to as a maximum display region. In the present specification, the DL means a double value of a distance between a centroid of the maximum display region and a point in the maximum display region farthest from the centroid, in a plane perpendicular to the optical axis Z. For example, in a case where the maximum display region is a rectangle, it is assumed that a length of a diagonal line of the rectangle is DL. For example, in a case where the maximum display region is a perfect circle, it is assumed that a diameter of the perfect circle is DL. For example, in a case where the maximum display region is an ellipse, it is assumed that a major axis of the ellipse is DL.

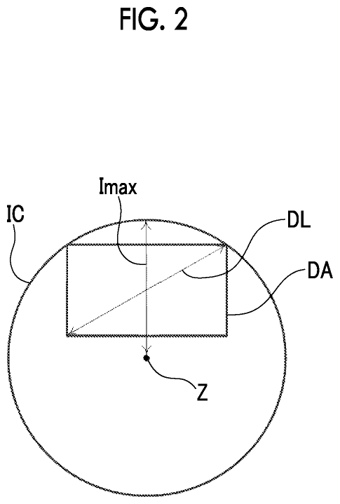

For example, FIG. 2 shows the rectangular maximum display region DA and the longest diameter DL of the maximum display region DA. In the example of FIG. 2, the diagonal length of the maximum display region DA is the longest diameter DL. FIG. 2 is a diagram showing a plane perpendicular to the optical axis Z, and also shows, for example, an effective image circle IC on the reduction side and the height Imax.

It is preferable that the projection optical system satisfies Conditional Expression (6). Here, it is assumed that a height of the maximum effective ray on the projection surface from the optical axis Z is Ymax. It is assumed that a paraxial image magnification of the projection optical system in a case where the magnification side is an object side and the reduction side is an image side is β. β is a value at the wide angle end in a case where the projection optical system is a variable magnification optical system. In a case where the magnification side is set as the object side, the height Ymax is a maximum object height of the projection optical system. It is necessary for the projection type display device to project a projected image without distortion at a visual level. By satisfying Conditional Expression (6), distortion can be suppressed, and thus it is possible to cope with the above-mentioned demand. In order to obtain more favorable characteristics, it is more preferable that the projection optical system satisfies Conditional Expression (6-1).

$$- 0.05 < ( I max - β \times Y max ) / ( β \times Y max ) < 0 \text{.05} \qquad ( 6 )$$

$$- 0. 3 < ( I max - β \times Y max ) / ( β \times Y max ) < 0.03 \qquad ( 6 - 1 )$$

It is preferable that the projection optical system satisfies Conditional Expression (7). Here, it is assumed that a sum of thicknesses of all optical elements on the optical axis, which have powers and are included in the range from the lens surface closest to the magnification side in the projection optical system to the lens surface closest to the reduction side in the projection optical system, is ΣTHpw. It is assumed that a sum of thicknesses of all optical elements, which have a refractive index of 1.8 or more at a d line, on the optical axis among the optical elements, which have the powers and are included in the range from the lens surface closest to the magnification side in the projection optical system to the lens surface closest to the reduction side in the projection optical system, is ΣTH18. By not allowing the result of Conditional Expression (7) to be equal to or less than the lower limit thereof, a proportion of optical elements with a refractive index of 1.8 or more at the d line among all the above-mentioned optical elements having powers is prevented from excessively becoming low. As a result, there is an advantage in satisfactorily correcting various aberrations such as spherical aberration while achieving reduction in size. Here, most optical materials having a refractive index of 1.8 or more at the d line each have a low transmittance. Therefore, by not allowing the result of Conditional Expression (7) to be equal to or greater than the upper limit thereof, the proportion is prevented from becoming excessively high. Therefore, it is possible to suppress a decrease in transmittance. Thereby, there is an advantage in ensuring a luminance of the optical engine. In order to obtain more favorable characteristics, it is more preferable that the projection optical system satisfies Conditional Expression (7-1).

$$0.27 < Σ TH 18 / Σ THpw < 0.5 \qquad ( 7 )$$

$$0.3 < Σ TH 18 / Σ TH pw < 0.4 \qquad ( 7 - 1 )$$

In a case where the intermediate image MI is formed on the inside of the projection optical system, the projection optical system includes the aperture stop St at a position closer to the reduction side than the intermediate image MI, and a real image of the aperture stop St is present on the inside of the projection optical system closer to the magnification side than the intermediate image MI. With such a configuration, it is preferable that the projection optical system satisfies Conditional Expression (8). Here, it is assumed that a position, at which a ray of light that is emitted from the outermost circumference of the effective image circle on the reduction side toward the magnification side and that passes through the center of the aperture stop St intersects with the optical axis Z at a position closer to the magnification side than the intermediate image MI, is Enp(Imax). It is assumed that a position of a paraxial image of the aperture stop St on the inside of the projection optical system closer to the magnification side than the intermediate image MI is Enp(0). The position Enp(Imax) and the position Enp(0) are positions in the optical axis direction. It is assumed that an air-equivalent distance on the optical axis from the position Enp(0) to the position Enp(Imax) is DifE. The sign of the air-equivalent distance DifE is positive in a case where the air-equivalent distance is a distance on the reduction side, and the sign is negative in a case where the air-equivalent distance is a distance on the magnification side, with reference to the position Enp(0). The air-equivalent distance DifE is a value at the wide angle end in a case where the projection optical system is a variable magnification optical system. By not allowing the corresponding value of Conditional Expression (8) to be equal to or less than the lower limit thereof, there is an advantage in reducing the total length of the projection optical system. By not allowing the result of Conditional Expression (8) to be equal to or greater than the upper limit thereof, it is possible to suppress an increase in diameter of the lens closest to the magnification side. In order to obtain more favorable characteristics, it is more preferable that the projection optical system satisfies Conditional Expression (8-1).

$$- 3 < DifE / I max < - 0.2 \qquad ( 8 )$$

$$- 2.5 < DifE / I max < - 0.5 \qquad ( 8 - 1 )$$

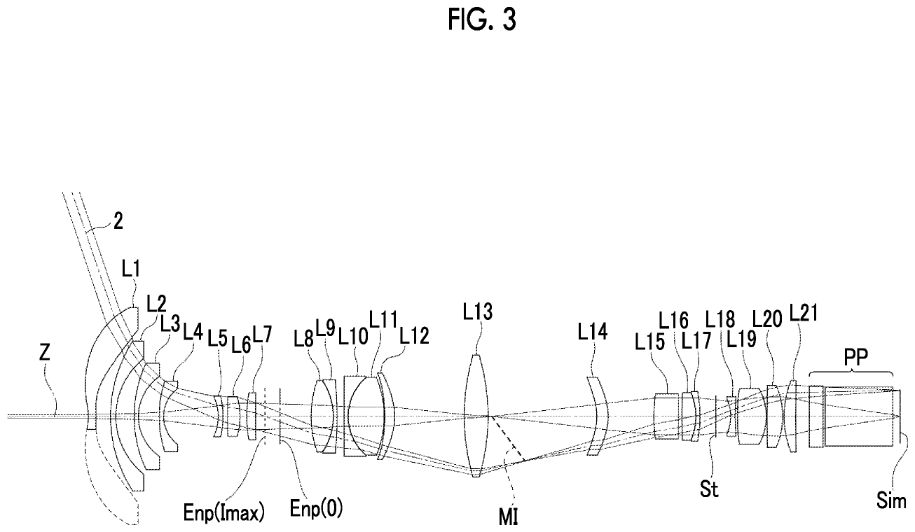

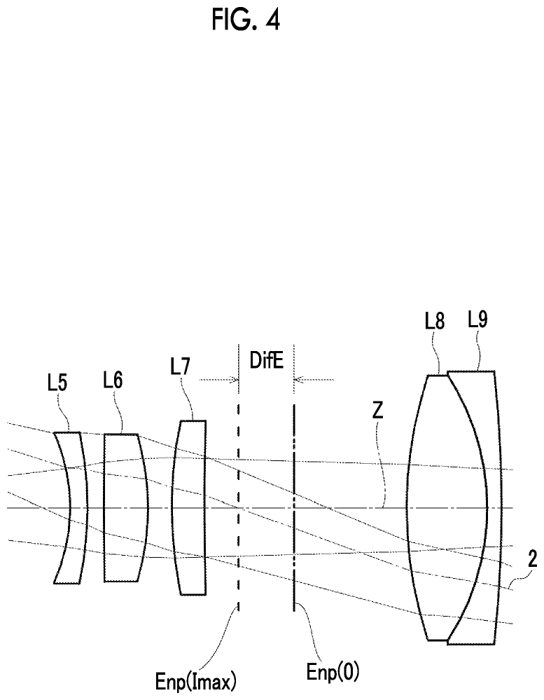

For example, FIGS. 3 and 4 show the position Enp(Imax) and the position Enp(0) in the projection optical system of FIG. 1. For ease of understanding, FIG. 3 shows a diagram in which the optical path is developed to be a linear optical path. FIG. 4 shows an enlarged view of a part including the position Enp(Imax) and the position Enp(0), and also shows the air-equivalent distance DifE. For example, in the projection optical system of FIG. 1, the position Enp(Imax) and the position Enp(0) are present between the lens L7 and the lens L8. In FIGS. 3 and 4, the position Enp(Imax) and the position Enp(0) are indicated by the dotted line and the two-dot chain line, respectively. The ray 2, which is emitted from the outermost circumference of the effective image circle on the reduction side and which passes through the center of the aperture stop St toward the magnification side, is indicated by the chain line.

It is preferable that the projection optical system according to the present disclosure includes three negative lenses successively in order from a position closest to the magnification side to the reduction side along the optical path. In such a case, there is an advantage in achieving an increase in angle of view. In order to further achieve an increase in angle of view, it is preferable that the projection optical system according to the present disclosure includes four negative lenses successively in order from the position closest to the magnification side to the reduction side along the optical path.

In the projection optical system according to the present disclosure, it is preferable that the lenses which are second and third from the magnification side are negative meniscus lenses having a convex surface facing toward the magnification side. In such a case, there is an advantage in achieving both wide angle and satisfactory aberration correction.

In the projection optical system according to the present disclosure, it is preferable that the lens closest to the intermediate image MI on the optical axis is a positive lens. In such a case, there is an advantage in achieving reduction in size.

It is preferable that the projection optical system according to the present disclosure is configured to be telecentric on the reduction side. In recent years, in order to realize a small-sized high-definition projection type display device, a so-called pixel shift method, in which a resolution of 2 times or 4 times the number of pixels of the display element is achieved by shifting the pixels, has been increased. In order to ensure a resolution, it is desirable to use a telecentric optical system.

In addition, the above-mentioned phrase “configured to be telecentric on the reduction side” includes an error that is practically allowed in the technical field to which the technique of the present disclosure belongs. The error may be, for example, in a range in which the angle formed between the principal ray incident on the display surface Sim and the optical axis Z in a case where ray tracing is performed from the magnification side to the reduction side is equal to or greater than −3 degrees and equal to or less than +3 degrees. In a system that does not include the aperture stop St, in a case where the luminous flux is viewed in the direction from the magnification side to the reduction side, the telecentricity may be determined by using, as a substitute for the principal ray, the bisector line of the maximum ray on the upper side and the maximum ray on the lower side in the cross section of the luminous flux focused on a point on the display surface Sim.

A lens closest to the magnification side in the projection optical system according to the present disclosure may be configured to have a shape in which a part of a rotationally symmetric shape is absent. In the projection optical system that projects a wide-angle image, a lens closest to the magnification side usually has the maximum effective diameter. Therefore, in a case where a part which is not used for forming the projected image in the lens closest to the magnification side, in which the lens diameter tends to be maximum in the projection optical system, is set as an absent part, the size reduction can be achieved. The lens L1 in FIG. 1 has a shape in which a part of the rotationally symmetric shape is absent under the optical axis Z, and the absent part is indicated by the dotted line in FIG. 1.

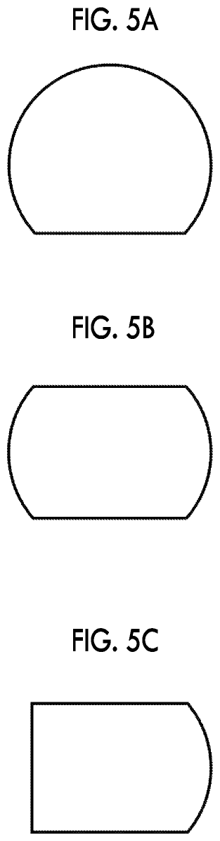

FIGS. 5A, 5B, and 5C show examples of the shape of the lens in a plane perpendicular to the optical axis Z in which the part of the rotationally symmetric shape is absent. In each of the examples shown in FIGS. 5A, 5B, and 5C, the plane perpendicular to the optical axis Z has a non-circular shape. By adopting such a non-circular shape, it is possible to achieve reduction in size and weight. The shape of the lens in which the part of the rotationally symmetric shape is absent is not limited to the examples shown in FIGS. 5A, 5B, and 5C, and may be another shape.

It is preferable that the projection optical system according to the present disclosure includes a focusing group which moves along the optical axis Z during focusing. Focusing is performed by moving the focusing group along the optical axis Z. The focusing group is not limited to a configuration in which the focusing group consists of a plurality of lenses, but the focusing group may consist of only one lens. For example, in the example of FIG. 1, the focusing group consists of the lenses L4 to L6. The parentheses below the lenses L4 to L6 and a double-headed arrow in a direction parallel to the optical axis Z in FIG. 1 indicate that the lenses L4 to L6 constitute a focusing group.

The above-mentioned preferred configurations and available configurations including the configurations relating to Conditional Expressions may be any combination, and it is preferable to appropriately and selectively adopt the configurations in accordance with necessary specification. Various modifications can be made without departing from the scope of the technique of the present disclosure. For example, in the technique of the present disclosure, the number of lenses included in the projection optical system and the shape of the lens may be different from the example in FIG. 1. In addition, a portion, in which the optical path deflection surface is disposed, may also be different from the example in FIG. 1.

For example, according to a preferable aspect of the present disclosure, the projection optical system projects an image, which is displayed on the display surface Sim of the display element on the reduction side, onto the projection surface on the magnification side. The projection optical system does not include a reflecting surface having a power but includes at least one optical path deflection surface that deflects the optical path by 90 degrees in the optical path of the projection optical system. The projection optical system satisfies Conditional Expressions (1) and (2).

Next, examples of the projection optical system according to the present disclosure will be described, with reference to the drawings. The reference numerals noted in the cross-sectional views of each example are used independently for each example in order to avoid complication of description and drawings due to an increase in number of digits of the reference numerals. Therefore, even in a case where common reference numerals are attached in the drawings of different examples, components do not necessarily have a common configuration.

### Example 1

FIG. 1 is a cross-sectional view of a configuration and luminous flux of a projection optical system of Example 1, and an illustration method and a configuration thereof are as described above. Therefore, some description is not repeated herein. The projection optical system of Example 1 includes, in order from the magnification side to the reduction side along the optical path, lenses L1 to L12, a reflection mirror Mr1, a lens L13, a reflection mirror Mr2, lenses L14 to L17, an aperture stop St, and lenses L18 to L21. The reflection mirror Mr1 and the reflection mirror Mr2 respectively have a reflecting surface R1 and a reflecting surface R2. The reflecting surface R1 and the reflecting surface R2 are surfaces having no power, and each of the reflecting surface R1 and the reflecting surface R2 functions as an optical path deflection surface that deflects the optical path by 90 degrees. The intermediate image MI near the optical axis is formed between the lens L13 and the reflection mirror Mr2. The focusing group consists of the lenses L4 to L6.

For the projection optical system of Example 1, basic lens data is shown in Table 1, specifications are shown in Table 2, variable surface spacing is shown in Table 3, and aspherical coefficients are shown in Table 4.

The table of basic lens data will be described as follows. The Sn column shows surface numbers in a case where the surface closest to the magnification side is the first surface and the number is increased one by one toward the reduction side. The r column shows a curvature radius of each surface. The d column shows a surface spacing between each surface and the surface adjacent to the reduction side on the optical axis. The nd column shows a refractive index of each component at the d line. The νd column shows an Abbe number of each component based on the d line.

In the table of the basic lens data, the sign of the curvature radius of the convex surface facing toward the magnification side is positive, and the sign of the curvature radius of the convex surface facing toward the reduction side is negative. In the fields of the surface numbers, the terms (R1), (R2), and (St) are also noted respectively on the surface corresponding to the optical path deflection surface on the magnification side, the surface corresponding to the optical path deflection surface on the reduction side, and the surface corresponding to the aperture stop St. In the table of basic lens data, the symbol DD[ ] is used for each variable surface spacing during focusing, and the magnification side surface number of the spacing is given in [ ] and is noted in the field of D.

Table 2 shows an absolute value |f| of the focal length, a back focal length Bf as the air-equivalent distance, an F number FNo., a maximum total angle of view 2ω, and Imax and DL used in the above conditional expressions, on the basis of the d line. [°] in the cells of 2ω indicates that the unit thereof is a degree.

Table 3 shows the variable surface spacings at respective projection distances. The projection distance is a distance on the optical axis from the conjugate plane on the magnification side (corresponding to the screen Scr in FIG. 1) to the lens surface closest to the magnification side.

In basic lens data, a reference sign * is attached to surface numbers of aspherical surfaces, and values of the paraxial curvature radius are written into the column of the curvature radius of the aspherical surface. In Table 4, the row of Sn shows surface numbers of the aspherical surfaces, and the rows of KA and Am (m=3, 4, 5, 6, . . . , 20) show numerical values of the aspherical coefficients for each aspherical surface. The “E±n” (n: an integer) in numerical values of the aspherical coefficients of Table 4 indicates “×10^{±n}”. KA and Am are the aspherical coefficients in the aspherical surface expression represented by the following expression.

$$Z d = C \times {h}^{2} / \{ 1 + {( 1 - KA \times {C}^{2} \times {h}^{2} )}^{1 / 2} \} + \sum Am \times {h}^{m}$$

Here,
Zd is an aspherical surface depth (a length of a perpendicular from a point on an aspherical surface at height h to a plane that is perpendicular to the optical axis Z and that is in contact with the vertex of the aspherical surface),
h is a height (a distance from the optical axis Z to the lens surface),
C is a reciprocal of the paraxial curvature radius,
KA and Am are aspherical coefficients, and
Σ in the aspherical surface expression means the sum with respect to m.

In the data of each table, degrees are used as a unit of an angle, and millimeters (mm) are used as a unit of a length, but appropriate different units may be used since the optical system can be used even in a case where the system is enlarged or reduced in proportion. Further, each of the following tables shows numerical values rounded off to predetermined decimal places.

TABLE 1
Example 1

| Sn | r | d | nd | γd |
|---|---|---|---|---|
| *1 | −7.7516 | 1.7068 | 1.53158 | 55.08 |
| *2 | −16.8703 | 3.1884 | | |
| 3 | 32.753 | 1.1855 | 1.87267 | 40.68 |
| 4 | 17.672 | 4.0512 | | |
| 5 | 30.2205 | 0.9480 | 1.77304 | 50.6 |
| 6 | 11.6701 | DD[6] | | |
| 7 | 27.2539 | 0.9731 | 1.73253 | 54.75 |
| 8 | 8.36 | 12.0642 | | |
| 9 | −11.4687 | 1.0426 | 1.60597 | 63.65 |
| 10 | −22.8454 | 1.0149 | | |
| 11 | 443.109 | 2.6806 | 1.79309 | 30.73 |
| 12 | −16.2305 | DD[12] | | |
| 13 | 26.9364 | 1.9602 | 1.55032 | 75.5 |
| 14 | 174.3084 | 12.3004 | | |
| 15 | 26.3927 | 4.9222 | 1.55032 | 75.5 |
| 16 | −15.3855 | 0.8514 | 1.74938 | 27.63 |
| 17 | −81.7619 | 1.5272 | | |
| 18 | 1078.619 | 0.8715 | 1.90992 | 19.55 |
| 19 | 12.1557 | 7.9766 | 1.57144 | 71.61 |
| 20 | −24.4623 | 0.1203 | | |
| *21 | −33.9121 | 2.2226 | 1.51007 | 56.24 |
| *22 | −13.8766 | 2.8600 | | |
| 23(R1) | ∞ | 12.5000 | | |
| 24 | 51.7002 | 5.2897 | 1.90632 | 36.88 |
| 25 | −51.0049 | 20.0000 | | |
| 26(R2) | ∞ | 4.0150 | | |
| *27 | −12.9555 | 2.5000 | 1.51007 | 56.24 |
| *28 | −13.3724 | 10.1500 | | |
| 29 | 43.1681 | 5.4010 | 1.90999 | 32.52 |
| 30 | −675.2912 | 0.7640 | | |
| 31 | 121.7484 | 2.9801 | 1.84975 | 42.93 |
| 32 | −14.704 | 0.9006 | 1.90988 | 19.51 |
| 33 | −34.2693 | 3.5400 | | |
| 34(St) | ∞ | 3.2516 | | |
| 35 | −10.2131 | 0.9745 | 1.72466 | 45.14 |
| 36 | 47.5455 | 0.4973 | | |
| 37 | 46.8467 | 6.3713 | 1.43875 | 94.66 |
| 38 | −13.9681 | 0.1922 | | |
| 39 | 284.1914 | 3.4386 | 1.497 | 81.61 |
| 40 | −18.8412 | 0.3189 | | |
| 41 | 23.2703 | 2.5917 | 1.81425 | 43.55 |
| 42 | 413.3913 | 3.0000 | | |
| 43 | ∞ | 3.0000 | 1.5168 | 64.2 |
| 44 | ∞ | 0.5000 | | |
| 45 | ∞ | 15.0000 | 1.67003 | 47.2 |
| 46 | ∞ | | | |

TABLE 2
Example 1

| | |
|---|---|
| \|f\| | 1.94 |
| Bf | 16.03 |
| FNo. | 2.01 |
| 2ω[°] | 144.0 |
| Imax | 6.00 |
| DL | 8.47 |

TABLE 3
Example 1

| Projection distance | 0.212 m | 0.160 m | 0.570 m |
|---|---|---|---|
| DD[6] | 4.69 | 4.58 | 4.42 |
| DD[12] | 1.31 | 1.43 | 1.59 |

TABLE 4
Example 1

| Sn | 1 | 2 | 21 | 22 |
|---|---|---|---|---|
| KA | −5.3037636E−01 | −2.5343639E+00 | −2.9823754E+00 | 6.9099676E−01 |
| A3 | 9.7252460E−03 | 1.2084856E−02 | −5.1135101E−05 | −2.3181216E−04 |
| A4 | −4.7287937E−05 | −2.1800900E−03 | −5.8484664E−05 | 1.6688743E−04 |
| A5 | −1.1508528E−04 | 6.3139370E−04 | 6.7000474E−06 | 1.4903703E−05 |
| A6 | 6.7066446E−06 | −1.2252415E−04 | 1.8933588E−05 | −9.4351586E−07 |
| A7 | 4.7217042E−07 | 1.1076074E−05 | −3.4243928E−06 | 1.2747422E−06 |
| A8 | −4.9193207E−08 | −2.0401544E−07 | −7.1695828E−07 | −3.2248374E−07 |
| A9 | −8.7426127E−10 | −3.6920347E−08 | 1.6400171E−07 | −5.8012287E−08 |
| A10 | 1.9670568E−10 | 2.3706250E−09 | 1.7515406E−08 | 1.7175837E−08 |
| A11 | −9.4217611E−13 | −4.3818288E−11 | −4.5219664E−09 | 1.1356033E−09 |
| A12 | −4.6081874E−13 | 3.5346778E−12 | −2.9571009E−10 | −4.3718411E−10 |
| A13 | 7.8878559E−15 | −1.8101326E−13 | 8.0529786E−11 | −1.1452888E−11 |
| A14 | 6.4046511E−16 | −1.4675971E−14 | 3.0363251E−12 | 6.3870807E−12 |
| A15 | −1.6296562E−17 | 2.2328470E−16 | −9.0135951E−13 | 5.6089147E−14 |
| A16 | −4.8431647E−19 | 1.5346074E−16 | −1.3745307E−14 | −5.5108511E−14 |
| A17 | 1.5896934E−20 | −1.1629984E−17 | 5.6733630E−15 | −8.7340930E−17 |
| A18 | 1.3568197E−22 | 3.4132586E−19 | −1.7436817E−17 | 2.6344800E−16 |
| A19 | −6.2843094E−24 | −3.8578104E−21 | −1.5118758E−17 | −1.1763911E−19 |
| A20 | 2.1703737E−26 | 4.1060027E−24 | 2.6664058E−19 | −5.4073652E−19 |

| Sn | 27 | 28 |
|---|---|---|
| KA | 8.9138696E−01 | 1.0585809E+00 |
| A3 | −2.0011122E−04 | −1.0972481E−05 |
| A4 | 3.2017721E−04 | 1.7063148E−04 |
| A5 | 4.0775679E−05 | 1.0130712E−05 |
| A6 | −2.5576398E−05 | 2.0124585E−06 |
| A7 | 3.3183437E−06 | −1.5187772E−06 |
| A8 | 7.3469520E−07 | 2.3441228E−08 |
| A9 | −2.0598307E−07 | 7.5368116E−08 |
| A10 | −5.3819603E−09 | −6.0001978E−09 |
| A11 | 5.0799773E−09 | −1.7021962E−09 |
| A12 | −1.4684862E−10 | 1.7636348E−10 |
| A13 | −6.8267518E−11 | 2.1375544E−11 |
| A14 | 3.9359331E−12 | −2.4269602E−12 |
| A15 | 5.2358440E−13 | −1.5535100E−13 |
| A16 | −4.0216062E−14 | 1.8076928E−14 |
| A17 | −2.1537929E−15 | 6.1485680E−16 |
| A18 | 1.9696372E−16 | −7.0779097E−17 |
| A19 | 3.6889344E−18 | −1.0289849E−18 |
| A20 | −3.8233130E−19 | 1.1484581E−19 |

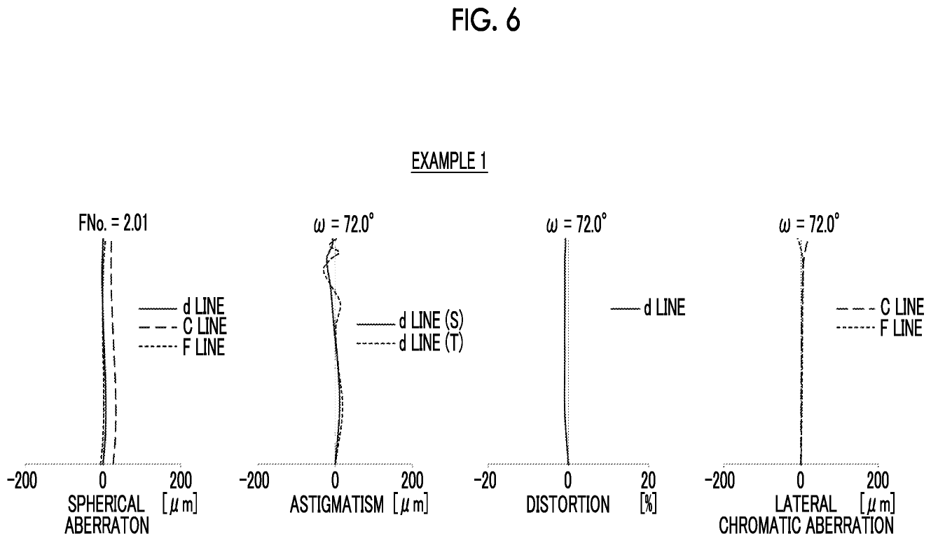

FIG. 6 shows a diagram of aberrations in the projection optical system of Example 1 in a state where the projection distance is 0.25 meters (m). FIG. 6 shows, in order from the left, spherical aberration, astigmatism, distortion, and lateral chromatic aberration. In the spherical aberration diagram, aberrations at the d line, C line, and F line are indicated by the solid line, the long broken line, and the short broken line, respectively. In the astigmatism diagram, the aberration at the d line in the sagittal direction is indicated by a solid line, and the aberration at the d line in the tangential direction is indicated by the short broken line. In the distortion diagram, aberration at the d line is indicated by the solid line. In the lateral chromatic aberration diagram, aberrations at the C line and the F line are indicated by the long broken line and the short broken line, respectively. In the spherical aberration diagram, the value of the F number is shown after “FNo.=”. In other aberration diagrams, the value of the maximum half angle of view is shown after “ω=”.

Symbols, meanings, description methods, and illustration methods of the respective data pieces according to Example 1 and the modification example are basically similar to those in the following examples unless otherwise specified. Therefore, in the following description, repeated description will not be given. It should be noted that in the cross-sectional view of the following examples, the screen Scr is not shown.

### Example 2

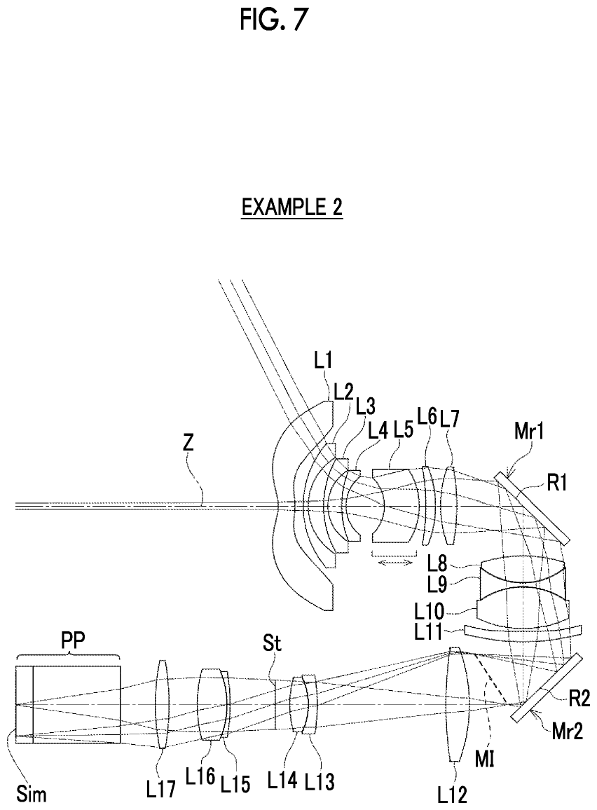

FIG. 7 shows a cross-sectional view of a configuration and luminous flux of a projection optical system of Example 2. The projection optical system of Example 2 includes, in order from the magnification side to the reduction side along the optical path, lenses L1 to L7, reflection mirror Mr1, lenses L8 to L11, a reflection mirror Mr2, lenses L12 to L14, an aperture stop St, and lenses L15 to L17. The reflection mirror Mr1 and the reflection mirror Mr2 respectively have a reflecting surface R1 and a reflecting surface R2. The reflecting surface R1 and the reflecting surface R2 are surfaces having no power, and each of the reflecting surface R1 and the reflecting surface R2 functions as an optical path deflection surface that deflects the optical path by 90 degrees. The intermediate image MI near the optical axis is formed between the reflection mirror Mr2 and the lens L12. The focusing group consists of the lens L5.

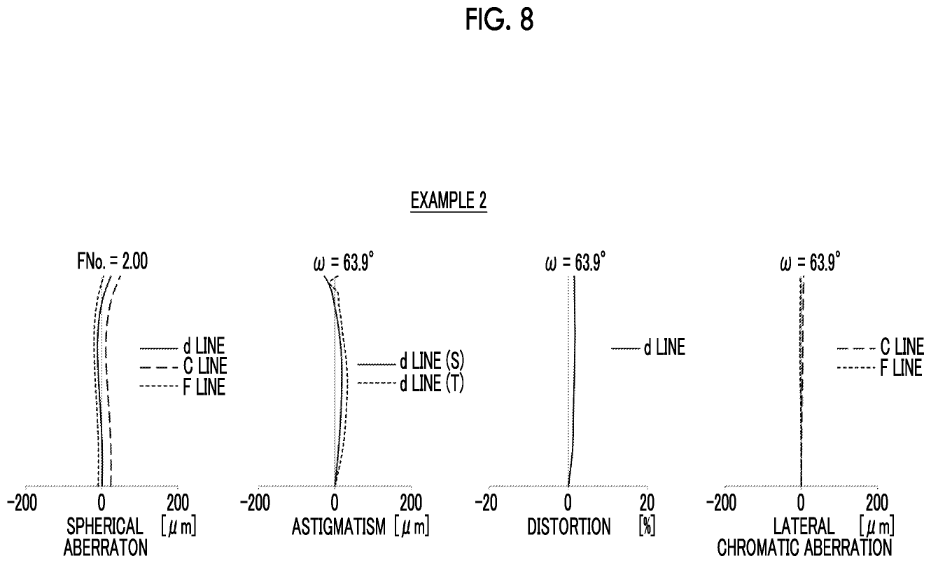

Regarding the projection optical system of Example 2, Table 5 shows basic lens data, Table 6 shows specifications, Table 7 shows variable surface spacings, Table 8 shows aspherical coefficients thereof, and FIG. 8 shows aberration diagrams. The aberration diagrams are in a state where the projection distance is 0.279 m (meters).

TABLE 5
Example 2

| Sn | r | d | nd | γd |
|---|---|---|---|---|
| *1 | −5.7999 | 2.8500 | 1.53158 | 55.08 |
| *2 | −10.5678 | 1.3540 | | |
| 3 | 17.1772 | 0.8550 | 1.80420 | 46.50 |
| 4 | 10.1112 | 2.6435 | | |
| 5 | 16.9718 | 0.7410 | 1.83481 | 42.72 |
| 6 | 7.4706 | 2.3631 | | |
| 7 | 17.1134 | 0.7410 | 1.83481 | 42.72 |
| 8 | 6.6990 | DD[8] | | |
| 9 | −7.0514 | 5.9999 | 1.48749 | 70.44 |
| 10 | −12.1244 | DD[10] | | |
| 11 | −39.6305 | 1.6555 | 1.80518 | 25.46 |
| 12 | −19.0871 | 0.8767 | | |
| 13 | 20.5428 | 2.7849 | 1.48749 | 70.44 |
| 14 | −37.7318 | 11.3542 | | |
| 15(R1) | ∞ | 8.8409 | | |
| 16 | 22.4979 | 4.7620 | 1.65160 | 58.54 |
| 17 | −11.2035 | 0.7410 | 1.84666 | 23.78 |
| 18 | 12.4016 | 7.3754 | 1.59282 | 68.62 |
| 19 | −17.6485 | 0.4991 | | |
| *20 | −1792.1148 | 1.8525 | 1.51007 | 56.24 |
| *21 | −41.6857 | 11.1502 | | |
| 22(R2) | ∞ | 9.1935 | | |
| 23 | 29.9833 | 4.0224 | 1.92286 | 20.88 |
| 24 | −71.0186 | 22.1206 | | |
| 25 | 33.1434 | 1.5009 | 1.92286 | 20.88 |
| 26 | 11.2287 | 0.0291 | | |
| 27 | 11.2848 | 3.0953 | 1.49700 | 81.54 |
| 28 | −17.8065 | 2.4644 | | |
| 29(St) | ∞ | 7.7701 | | |
| 30 | 33.5893 | 0.5191 | 1.90366 | 31.31 |
| 31 | 16.1638 | 0.0290 | | |
| 32 | 16.2509 | 5.0905 | 1.49700 | 81.54 |
| 33 | −24.9533 | 4.8414 | | |
| 34 | 46.5654 | 2.3594 | 1.92286 | 20.88 |
| 35 | −39.7011 | 6.0029 | | |
| 36 | ∞ | 15.0000 | 1.67003 | 47.20 |
| 37 | ∞ | 3.0000 | 1.48749 | 70.44 |
| 38 | ∞ | | | |

TABLE 6
Example 2

| | |
|---|---|
| \|f\| | 2.67 |
| Bf | 16.98 |
| FNo. | 2.00 |
| 2ω[°] | 127.8 |
| Imax | 5.6 |
| DL | 8.47 |

TABLE 7
Example 2

| Projection distance | 0.279 m | 0.200 m | 0.570 m |
|---|---|---|---|
| DD[8] | 6.59 | 6.47 | 6.74 |
| DD[10] | 1.14 | 1.26 | 0.99 |

TABLE 8
Example 2

| Sn | 1 | 2 | 20 | 21 |
|---|---|---|---|---|
| KA | −3.3439740E+00 | −4.9999906E+00 | 8.6597976E−06 | −5.0000076E+00 |
| A3 | 7.5963127E−03 | 6.2382908E−03 | 0.0000000E+00 | 0.0000000E+00 |
| A4 | −6.2933714E−04 | 9.4619045E−04 | −1.3935446E−04 | −3.0165687E−05 |
| A5 | 3.3002673E−05 | −1.0324457E−04 | 6.3786367E−06 | −5.7210965E−06 |
| A6 | 2.4049042E−06 | −1.8466450E−05 | −3.1057789E−06 | 2.3901562E−06 |
| A7 | −1.5156180E−06 | 2.7557481E−06 | 1.5873508E−07 | −1.4652229E−06 |
| A8 | 1.8613445E−07 | 9.1798158E−08 | 4.6083294E−08 | 2.4761229E−07 |
| A9 | 2.1197178E−09 | −2.7161239E−08 | −3.1988785E−09 | 1.0739295E−08 |
| A10 | −1.9323861E−09 | −2.8647355E−11 | −1.7920935E−10 | −5.4102545E−09 |
| A11 | 8.2845667E−11 | 1.4908754E−10 | 1.9186998E−11 | 1.4432424E−10 |
| A12 | 7.5625915E−12 | −2.2598490E−12 | 1.4548501E−13 | 5.0780320E−11 |
| A13 | −6.0619046E−13 | −4.6582204E−13 | −5.6894702E−14 | −2.4793687E−12 |
| A14 | −1.0034491E−14 | 1.1546269E−14 | 7.1519653E−16 | −2.6226970E−13 |
| A15 | 1.8404401E−15 | 8.2855999E−16 | 9.1070110E−17 | 1.3771357E−14 |
| A16 | −1.2987901E−17 | −2.6019640E−17 | −2.0563259E−18 | 7.8162792E−16 |
| A17 | −2.6612625E−18 | −7.8297502E−19 | −7.5306547E−20 | −3.3898186E−17 |
| A18 | 4.9934663E−20 | 2.8564582E−20 | 2.0938507E−21 | −1.2720420E−18 |
| A19 | 1.5066095E−21 | 3.0485035E−22 | 2.5239576E−23 | 3.1406171E−20 |
| A20 | −3.8812505E−23 | −1.2412568E−23 | −7.6932272E−25 | 8.8156419E−22 |

### Example 3

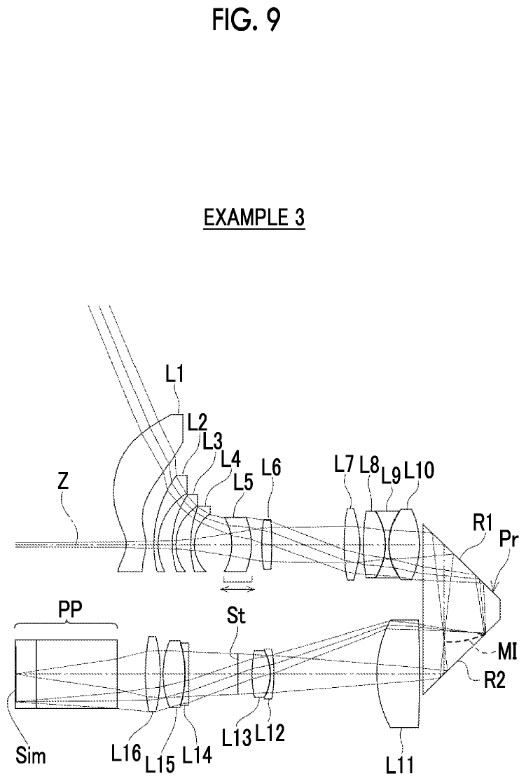

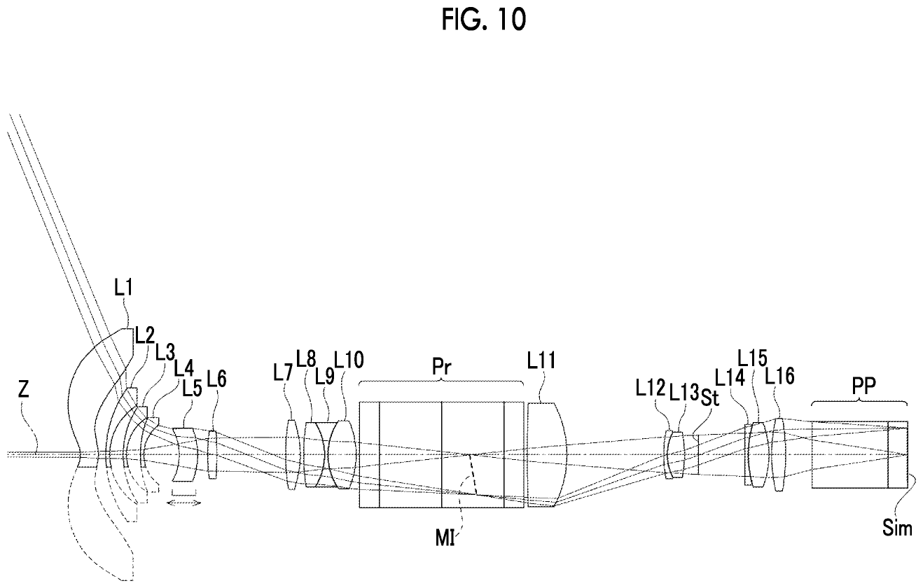

FIG. 9 shows a cross-sectional view of a configuration and luminous flux of a projection optical system of Example 3. FIG. 10 shows a diagram in which the optical path of the projection optical system of Example 3 is developed to be a linear optical path. The projection optical system of Example 3 includes, in order from the magnification side to the reduction side along the optical path, lenses L1 to L10, prisms Pr, lenses L11 to L13, an aperture stop St, and lenses L14 to L16. The prism Pr is an optical path deflecting member which deflects the optical path. The prism Pr has two reflecting surfaces R1 and R2. The reflecting surface R1 and the reflecting surface R2 are surfaces having no power, and each of the reflecting surface R1 and the reflecting surface R2 functions as an optical path deflection surface that deflects the optical path by 90 degrees. The intermediate image MI near the optical axis is formed between the reflecting surface R1 and the reflecting surface R2. The focusing group consists of the lens L5. The lenses L1 to L4 each have a shape in which a part of the rotationally symmetric shape is absent. In FIG. 9, the illustration of the absent part is omitted, and in FIG. 10, the absent part is shown by the dotted line.

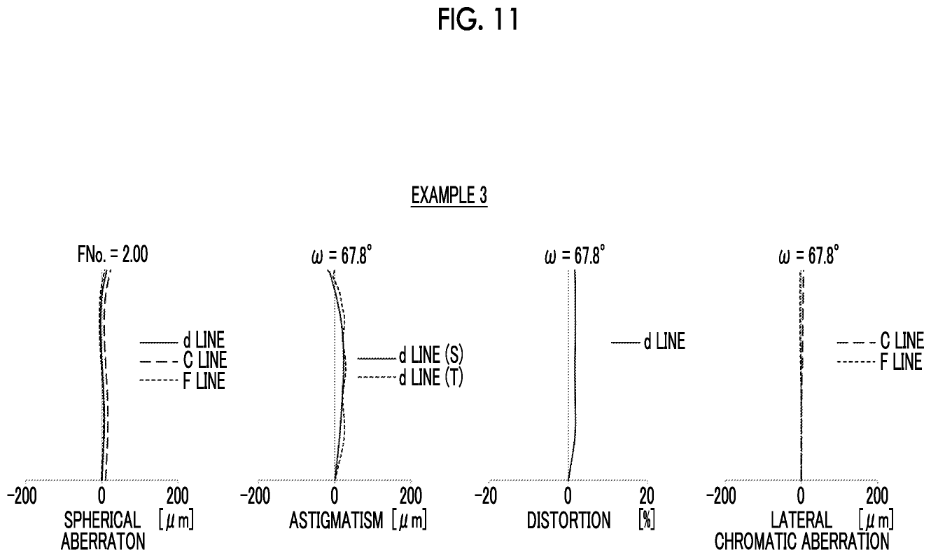

Regarding the projection optical system of Example 3, Table 9 shows basic lens data, Table 10 shows specifications, Table 11 shows variable surface spacings, Table 12 shows aspherical coefficients thereof, and FIG. 11 shows aberration diagrams. The aberration diagrams are in a state where the projection distance is 0.237 m (meters).

TABLE 9
Example 3

| Sn | r | d | nd | γd |
|---|---|---|---|---|
| *1 | −2.7074 | 2.7009 | 1.53158 | 55.08 |
| *2 | −4.6051 | 1.1206 | | |
| 3 | 17.3412 | 0.6000 | 1.88300 | 40.80 |
| 4 | 8.8746 | 2.0244 | | |
| 5 | 13.0764 | 0.5200 | 1.83481 | 42.72 |
| 6 | 6.6804 | 2.0960 | | |
| 7 | 15.3345 | 0.5200 | 1.80420 | 46.50 |
| 8 | 5.5790 | DD[8] | | |
| 9 | −8.0396 | 2.7848 | 1.48749 | 70.44 |
| 10 | −10.6056 | DD[10] | | |
| 11 | 23.4951 | 1.4299 | 1.86966 | 20.02 |
| 12 | −38.8123 | 10.3200 | | |
| *13 | 36.8740 | 2.2306 | 1.58313 | 59.38 |
| *14 | −13.1049 | 0.5000 | | |
| 15 | 30.6928 | 3.1547 | 1.62041 | 60.34 |
| 16 | −9.0909 | 0.5200 | 1.84666 | 23.78 |
| 17 | 9.0909 | 4.2588 | 1.59282 | 68.62 |
| 18 | −12.5000 | 0.5000 | | |
| 19 | ∞ | 3.0000 | 1.56883 | 56.04 |
| 20(R1) | ∞ | 9.4479 | 1.56883 | 56.04 |
| 21 | ∞ | 9.4479 | 1.56883 | 56.04 |
| 22(R2) | ∞ | 3.0000 | 1.56883 | 56.04 |
| 23 | ∞ | 0.5000 | | |
| 24 | 229.6278 | 6.0009 | 1.92286 | 20.88 |
| 25 | −16.7650 | 14.6796 | | |
| 26 | 20.0193 | 0.5192 | 1.92286 | 20.88 |
| 27 | 7.3590 | 0.0305 | | |
| 28 | 7.3819 | 2.5814 | 1.49700 | 81.61 |
| 29 | −17.2560 | 1.9988 | | |
| 30(St) | ∞ | 7.0488 | | |
| 31 | 2794.3293 | 0.5210 | 1.84666 | 23.78 |
| 32 | 16.9086 | 3.1116 | 1.49700 | 81.61 |
| 33 | −13.5266 | 0.4005 | | |
| 34 | 23.7363 | 2.1195 | 1.92286 | 20.88 |
| 35 | −32.1947 | 3.9260 | | |
| 36 | ∞ | 11.5000 | 1.67003 | 47.20 |
| 37 | ∞ | 3.0000 | 1.51680 | 64.20 |
| 38 | ∞ | | | |

TABLE 10
Example 3

| | |
|---|---|
| \|f\| | 1.59 |
| Bf | 12.78 |
| FNo. | 2.00 |
| 2ω[°] | 135.6 |
| Imax | 4.05 |
| DL | 5.95 |

TABLE 11
Example 3

| Projection distance | 0.237 m | 0.200 m | 0.570 m |
|---|---|---|---|
| DD[8] | 5.35 | 5.22 | 5.87 |
| DD[10] | 1.49 | 1.63 | 0.97 |

TABLE 12
Example 3

| Sn | 1 | 2 | 13 | 14 |
|---|---|---|---|---|
| KA | −1.1492190E+00 | −1.5679723E+00 | 1.0000000E+00 | 1.0000000E+00 |
| A3 | 2.1787329E−02 | 1.3051107E−02 | 0.0000000E+00 | 0.0000000E+00 |
| A4 | −2.7011125E−03 | 1.4360349E−03 | −6.3113968E−05 | 3.0386033E−04 |
| A5 | −6.0353022E−05 | −2.5453309E−04 | 6.1227327E−05 | −1.2411180E−04 |
| A6 | 4.6770932E−05 | −4.7389812E−05 | −6.3290517E−06 | 8.8691496E−05 |
| A7 | −3.0265478E−06 | 8.3288248E−06 | −1.8799049E−07 | −2.4827126E−05 |
| A8 | −2.6721817E−07 | 3.5124788E−07 | 6.2992782E−08 | 1.8962299E−06 |
| A9 | 3.7730970E−08 | −1.1281585E−07 | −9.2758147E−10 | 5.7497854E−07 |
| A10 | 2.2131065E−10 | 2.0163857E−10 | −2.5530269E−10 | −1.1741712E−07 |
| A11 | −2.0836311E−10 | 8.3447784E−10 | 5.8268733E−12 | −3.2792597E−09 |
| A12 | 4.5458201E−12 | −1.9953412E−11 | 5.4008618E−13 | 2.0150483E−09 |
| A13 | 6.3529261E−13 | −3.5053643E−12 | −1.3904499E−14 | −2.2211995E−11 |
| A14 | −2.3896232E−14 | 1.2922326E−13 | −6.2725973E−16 | −1.7393377E−11 |
| A15 | −1.0995134E−15 | 8.3763287E−15 | 1.7588689E−17 | 3.4594189E−13 |
| A16 | 5.4655111E−17 | −3.8165691E−16 | 3.7558372E−19 | 8.2540263E−14 |
| A17 | 1.0066335E−18 | −1.0622001E−17 | −1.1611332E−20 | −1.4771866E−15 |
| A18 | −6.1703477E−20 | 5.5298591E−19 | −8.6267404E−23 | −2.0583615E−16 |
| A19 | −3.7622718E−22 | 5.5477107E−21 | 3.1438023E−24 | 2.1605043E−18 |
| A20 | 2.8007492E−23 | −3.1792714E−22 | −3.5239343E−27 | 2.1134870E−19 |

### Example 4

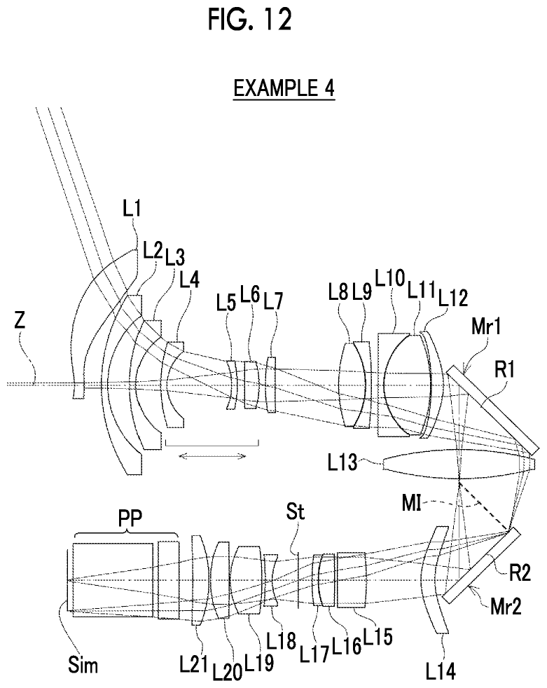

FIG. 12 shows a cross-sectional view of a configuration and luminous flux of a projection optical system of Example 4. The projection optical system of Example 4 includes, in order from the magnification side to the reduction side along the optical path, lenses L1 to L12, a reflection mirror Mr1, a lens L13, a reflection mirror Mr2, lenses L14 to L17, an aperture stop St, and lenses L18 to L21. The reflection mirror Mr1 and the reflection mirror Mr2 respectively have a reflecting surface R1 and a reflecting surface R2. The reflecting surface R1 and the reflecting surface R2 are surfaces having no power, and each of the reflecting surface R1 and the reflecting surface R2 functions as an optical path deflection surface that deflects the optical path by 90 degrees. The intermediate image MI near the optical axis is formed between the lens L13 and the reflection mirror Mr2. The focusing group consists of the lenses LA to L6. The lens L1 has a shape in which a part of a rotationally symmetric shape is absent. In FIG. 12, the illustration of the absent part is omitted.

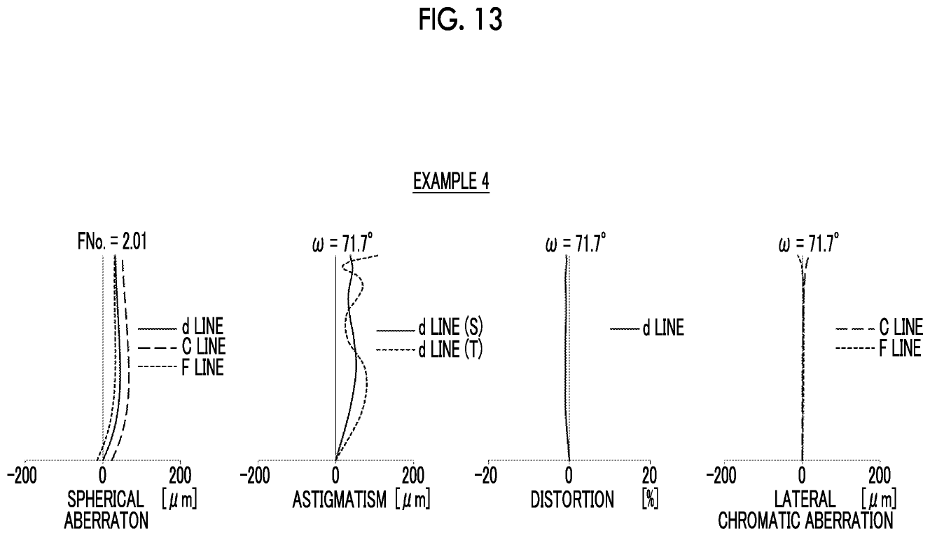

Regarding the projection optical system of Example 4, Table 13 shows basic lens data, Table 14 shows specifications, Table 15 shows variable surface spacings, Table 16 shows aspherical coefficients thereof, and FIG. 13 shows aberration diagrams. The aberration diagrams are in a state where the projection distance is 0.212 m (meters).

TABLE 13
Example 4

| Sn | r | d | nd | γd |
|---|---|---|---|---|
| *1 | −6.0386 | 1.3800 | 1.53158 | 55.08 |
| *2 | −13.1532 | 2.5200 | | |
| 3 | 25.7051 | 0.9010 | 1.89027 | 38.97 |
| 4 | 13.5893 | 3.1938 | | |
| 5 | 23.8806 | 0.9003 | 1.75099 | 52.9 |
| 6 | 9.0338 | DD[6] | | |
| 7 | 21.2414 | 0.9097 | 1.70576 | 56.21 |
| 8 | 6.5406 | 9.4252 | | |
| 9 | −8.9597 | 0.8010 | 1.60903 | 63.23 |
| 10 | −17.8627 | 1.0661 | | |
| 11 | 345.4634 | 2.1205 | 1.75914 | 28.86 |
| 12 | −12.683 | DD[12] | | |
| 13 | 20.9789 | 1.4241 | 1.54265 | 73.05 |
| 14 | 135.9828 | 9.2739 | | |
| 15 | 20.6194 | 3.9154 | 1.55995 | 70.78 |
| 16 | −12.0273 | 0.8510 | 1.7297 | 28.52 |
| 17 | −63.9899 | 0.9373 | | |
| 18 | 889.788 | 0.8709 | 1.90999 | 19.5 |
| 19 | 9.4957 | 6.7416 | 1.56854 | 69.45 |
| 20 | −19.3015 | 0.1202 | | |
| *21 | −26.3897 | 1.7588 | 1.51007 | 56.24 |
| *22 | −10.8309 | 2.3000 | | |
| 23(R1) | ∞ | 9.7000 | | |
| 24 | 41.17 | 4.3686 | 1.90692 | 37.31 |
| 25 | −40.3564 | 15.2000 | | |
| 26(R2) | ∞ | 3.5600 | | |
| *27 | −10.1283 | 2.0102 | 1.51007 | 56.24 |
| *28 | −10.436 | 7.8832 | | |
| 29 | 33.7634 | 4.2395 | 1.91 | 31.57 |
| 30 | −525.9858 | 0.3794 | | |
| 31 | 95.4408 | 2.3912 | 1.83989 | 38.63 |
| 32 | −11.4419 | 0.9097 | 1.91 | 19.5 |
| 33 | −26.6763 | 2.0300 | | |
| 34(St) | ∞ | 3.7759 | | |
| 35 | −7.9788 | 0.9993 | 1.70665 | 42.92 |
| 36 | 37.3445 | 0.4929 | | |
| 37 | 36.4101 | 4.6062 | 1.43875 | 94.66 |
| 38 | −10.9175 | 0.1486 | | |
| 39 | 214.189 | 2.7583 | 1.46283 | 85.72 |
| 40 | −14.2548 | 0.2060 | | |
| 41 | 18.1859 | 2.3827 | 1.78435 | 47.49 |
| 42 | 320.707 | 3.6612 | | |
| 43 | ∞ | 3.0000 | 1.5168 | 64.2 |
| 44 | ∞ | 0.8000 | | |
| 45 | ∞ | 11.5000 | 1.67003 | 47.2 |
| 46 | ∞ | | | |

TABLE 14
Example 4

| | |
|---|---|
| \|f\| | 1.52 |
| Bf | 12.51 |
| FNo. | 2.01 |
| 2ω[°] | 143.4 |
| Imax | 4.6 |
| DL | 5.95 |

TABLE 15
Example 4

| Projection distance | 0.212 m | 0.160 m | 0.570 m |
|---|---|---|---|
| DD[6] | 3.59 | 3.66 | 3.45 |
| DD[12] | 0.89 | 0.82 | 1.04 |

TABLE 16
Example 4

| Sn | 1 | 2 | 21 | 22 |
|---|---|---|---|---|
| KA | −5.3037636E−01 | −2.5343639E+00 | −2.9823754E+00 | 6.9099676E−01 |
| A3 | 1.6270757E−02 | 1.9815060E−02 | 2.4212140E−04 | −3.6574163E−04 |
| A4 | −1.0017047E−04 | −4.4923184E−03 | −2.1056093E−04 | 4.3629416E−04 |
| A5 | −3.1987983E−04 | 1.6972467E−03 | 3.1604455E−05 | 9.1561452E−05 |
| A6 | 2.3271436E−05 | −4.2583755E−04 | 6.8789910E−05 | −3.2021533E−05 |
| A7 | 2.2624555E−06 | 4.8688328E−05 | −2.3382285E−05 | −1.7414613E−06 |
| A8 | −2.8317896E−07 | −1.0131006E−06 | −3.0531253E−06 | 1.4526095E−06 |
| A9 | −8.0637279E−09 | −2.6697846E−07 | 1.9435975E−06 | 7.6842737E−09 |
| A10 | 1.8885716E−09 | 1.9791958E−08 | 4.0548355E−08 | −2.8321363E−08 |
| A11 | −1.1506337E−12 | −4.9349200E−10 | −8.6291254E−08 | −4.4317839E−11 |
| A12 | −7.4431594E−12 | 7.2154900E−11 | 1.5271442E−09 | −4.1855433E−10 |
| A13 | 1.1810519E−13 | −3.7324217E−12 | 2.3232477E−09 | 3.4898943E−11 |
| A14 | 1.7661474E−14 | −4.6593504E−13 | −8.1509607E−11 | 3.2962867E−11 |
| A15 | −4.4482768E−16 | 8.2189761E−15 | −3.8026097E−11 | −1.3028270E−12 |
| A16 | −2.3599463E−17 | 6.5587356E−15 | 1.6656905E−12 | −6.9951128E−13 |
| A17 | 7.4302418E−19 | −6.0672900E−16 | 3.4800776E−13 | 1.8393499E−14 |
| A18 | 1.3687293E−20 | 2.2092523E−17 | −1.6779179E−14 | 6.9493974E−15 |
| A19 | −4.9422537E−22 | −3.2529157E−19 | −1.3620466E−15 | −9.4526861E−17 |
| A20 | 6.6990816E−26 | 8.8883000E−22 | 6.8096255E−17 | −2.7628051E−17 |

| Sn | 27 | 28 |
|---|---|---|
| KA | 8.9138696E−01 | 1.0585809E+00 |
| A3 | −1.0837632E−03 | 5.2253772E−05 |
| A4 | 8.6290232E−04 | 2.4951778E−04 |
| A5 | 2.7569186E−04 | 9.7327540E−05 |
| A6 | −1.2131281E−04 | 1.8696453E−05 |
| A7 | −4.1490383E−06 | −1.6113029E−05 |
| A8 | 7.0494169E−06 | −8.0285068E−07 |
| A9 | −3.6292805E−07 | 1.1137690E−06 |
| A10 | −2.0133325E−07 | −8.6613019E−09 |
| A11 | 2.1375815E−08 | −3.8996384E−08 |
| A12 | 2.7315600E−09 | 1.1943157E−09 |
| A13 | −5.3166436E−10 | 7.7590414E−10 |
| A14 | −3.8039854E−12 | −3.0613440E−11 |
| A15 | 7.1639295E−12 | −8.9327702E−12 |
| A16 | −3.7868484E−13 | 3.6975716E−13 |
| A17 | −5.1070056E−14 | 5.5652213E−14 |
| A18 | 4.5535769E−15 | −2.2030232E−15 |
| A19 | 1.5108650E−16 | −1.4564490E−16 |
| A20 | −1.7093201E−17 | 5.2013309E−18 |

### Example 5

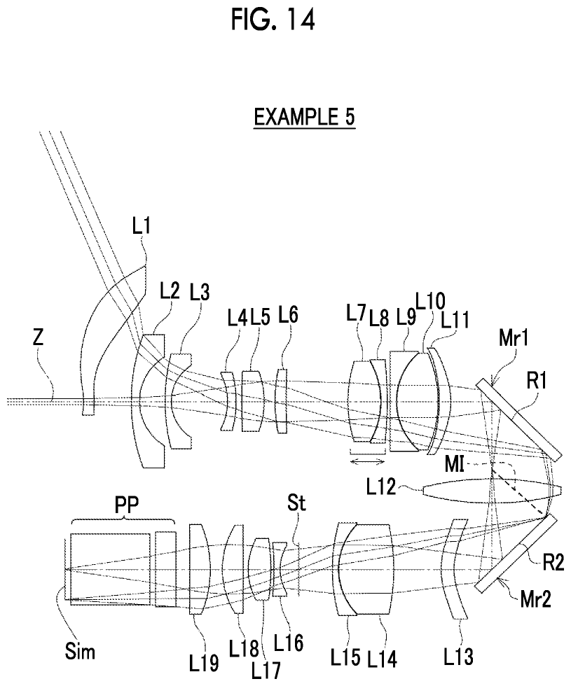

FIG. 14 shows a cross-sectional view of a configuration and luminous flux of a projection optical system of Example 5. The projection optical system of Example 5 includes, in order from the magnification side to the reduction side along the optical path, lenses L1 to L11, a reflection mirror Mr1, a lens L12, a reflection mirror Mr2, lenses L13 to L15, an aperture stop St, and lenses L16 to L19. The reflection mirror Mr1 and the reflection mirror Mr2 respectively have a reflecting surface R1 and a reflecting surface R2. The reflecting surface R1 and the reflecting surface R2 are surfaces having no power, and each of the reflecting surface R1 and the reflecting surface R2 functions as an optical path deflection surface that deflects the optical path by 90 degrees. The intermediate image MI near the optical axis is formed between the reflection mirror Mr1 and the lens L12. The focusing group consists of the lenses L7 and L8. The lens L1 has a shape in which a part of a rotationally symmetric shape is absent. In FIG. 14, the illustration of the absent part is omitted.

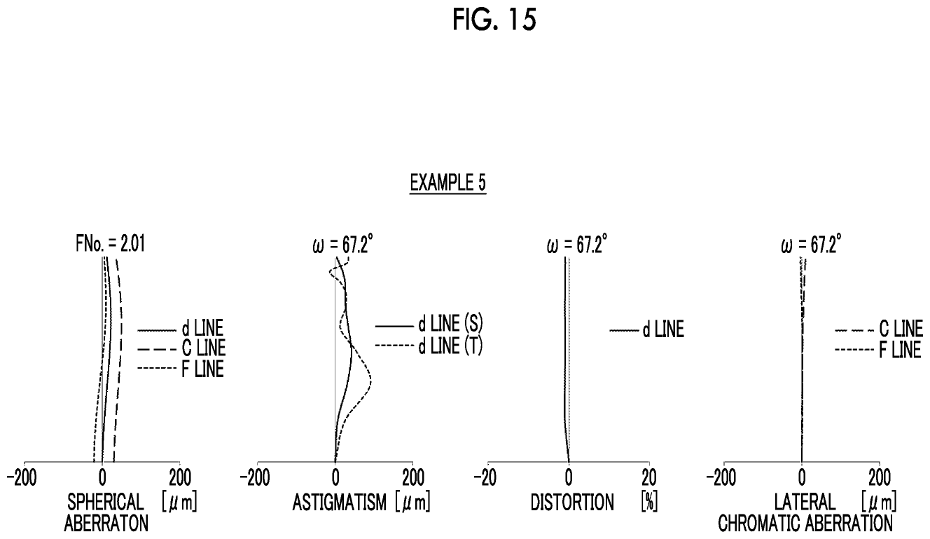

Regarding the projection optical system of Example 5, Table 17 shows basic lens data, Table 18 shows specifications, Table 19 shows variable surface spacings, Table 20 shows aspherical coefficients thereof, and FIG. 15 shows aberration diagrams. The aberration diagrams are in a state where the projection distance is 0.279 m (meters).

TABLE 17
Example 5

| Sn | r | d | nd | γd |
|---|---|---|---|---|
| *1 | −6.1897 | 1.5275 | 1.53158 | 55.08 |
| *2 | −12.2632 | 5.3874 | | |
| 3 | 29.5729 | 1.1990 | 1.80182 | 47.66 |
| 4 | 7.9392 | 3.7304 | | |
| 5 | 29.5394 | 0.9009 | 1.76967 | 40.85 |
| 6 | 6.496 | 8.1757 | | |
| 7 | −9.1115 | 1.2525 | 1.89918 | 28.19 |
| 8 | −16.789 | 0.8331 | | |
| 9 | 148.9079 | 3.2679 | 1.69259 | 31.81 |
| 10 | −13.1297 | 1.5832 | | |
| 11 | 24.0132 | 1.6051 | 1.90876 | 32.38 |
| 12 | 100.1081 | DD[12] | | |
| 13 | 20.363 | 4.7795 | 1.50116 | 55.96 |
| 14 | −12.4415 | 0.9238 | 1.81879 | 38.25 |
| 15 | −65.3742 | DD[15] | | |
| 16 | 10839.7416 | 0.9481 | 1.90703 | 19.82 |
| 17 | 9.8498 | 6.0478 | 1.66772 | 58.04 |
| 18 | −18.1391 | 0.1751 | | |
| *19 | −19.0895 | 1.7010 | 1.51007 | 56.24 |
| *20 | −10.6107 | 6.0000 | | |
| 21(R1) | ∞ | 11.6444 | | |
| 22 | 40.9995 | 3.6659 | 1.78178 | 34.01 |
| 23 | −38.9745 | 10.0000 | | |
| 24(R2) | ∞ | 5.5277 | | |
| *25 | −10.0994 | 1.9028 | 1.51007 | 56.24 |
| *26 | −10.8528 | 6.9070 | | |
| 27 | 32.784 | 8.0196 | 1.90744 | 32.31 |
| 28 | −9.9442 | 0.9086 | 1.86891 | 21.64 |
| 29 | −26.9438 | 4.9100 | | |
| 30(St) | ∞ | 2.6149 | | |
| 31 | −7.1132 | 0.9010 | 1.7671 | 32.97 |
| 32 | 46.2487 | 0.4375 | | |
| 33 | 31.4496 | 3.3314 | 1.43875 | 94.66 |
| 34 | −9.8754 | 0.7215 | | |
| 35 | 1212.356 | 3.0353 | 1.45657 | 86.68 |
| 36 | −12.9526 | 1.7472 | | |
| 37 | 18.1408 | 2.9885 | 1.86867 | 40.5 |
| 38 | 1216.8816 | 3.6659 | | |
| 39 | ∞ | 3.0000 | 1.5168 | 64.2 |
| 40 | ∞ | 0.8000 | | |
| 41 | ∞ | 11.5000 | 1.67003 | 47.2 |
| 42 | ∞ | | | |

TABLE 18
Example 5

| | |
|---|---|
| \|f\| | 1.92 |
| Bf | 12.52 |
| FNo. | 2.01 |
| 2ω[°] | 134.4 |
| Imax | 4.6 |
| DL | 5.95 |

TABLE 19
Example 5

| Projection distance | 0.279 m | 0.160 m | 0.570 m |
|---|---|---|---|
| DD[12] | 8.93 | 8.75 | 9.06 |
| DD[15] | 0.42 | 0.60 | 0.29 |

TABLE 20
Example 5

| Sn | 1 | 2 | 19 | 20 |
|---|---|---|---|---|
| KA | −5.4212575E−01 | −2.5807402E+00 | −3.0969300E+00 | 7.3830461E−01 |
| A3 | 1.6231168E−02 | 1.9719166E−02 | 2.5457963E−04 | −6.5046904E−04 |
| A4 | −1.1164576E−04 | −4.4910547E−03 | −5.7011782E−05 | 6.0004450E−04 |
| A5 | −3.1840830E−04 | 1.7036792E−03 | −3.0385024E−05 | 1.3712788E−04 |
| A6 | 2.3566627E−05 | −4.2582932E−04 | 4.9633876E−05 | −7.2754087E−05 |
| A7 | 2.2355903E−06 | 4.8483906E−05 | −1.2860558E−05 | −4.2915933E−06 |
| A8 | −2.8704557E−07 | −1.0141317E−06 | −1.3334230E−06 | 6.1873243E−06 |
| A9 | −7.7930333E−09 | −2.6344462E−07 | 1.1122937E−06 | 1.2525411E−08 |
| A10 | 1.9178805E−09 | 1.9814092E−08 | −6.8894109E−08 | −3.3010275E−07 |
| A11 | −2.7639256E−12 | −5.2931324E−10 | −4.9203875E−08 | 5.4806538E−09 |
| A12 | −7.5788782E−12 | 7.1915184E−11 | 6.2816434E−09 | 1.1045434E−08 |
| A13 | 1.2393581E−13 | −3.5133975E−12 | 1.3324310E−09 | −2.2341273E−10 |
| A14 | 1.8049724E−14 | −4.6445031E−13 | −2.1623014E−10 | −2.3436205E−10 |
| A15 | −4.5737485E−16 | 7.4241624E−15 | −2.2251815E−11 | 4.0853827E−12 |
| A16 | −2.4265536E−17 | 6.5534203E−15 | 4.0097625E−12 | 3.0596290E−12 |
| A17 | 7.5780936E−19 | −6.0515290E−16 | 2.0960004E−13 | −3.6454711E−14 |
| A18 | 1.4311052E−20 | 2.2102762E−17 | −3.9304010E−14 | −2.2335771E−14 |
| A19 | −5.0156804E−22 | −3.2660689E−19 | −8.4573784E−16 | 1.2610760E−16 |
| A20 | −1.7577761E−25 | 8.8061201E−22 | 1.5915707E−16 | 6.9509061E−17 |

| Sn | 25 | 26 |
|---|---|---|
| KA | 9.8920631E−01 | 9.5588928E−01 |
| A3 | −5.7797078E−04 | 1.5272970E−04 |
| A4 | 4.8886916E−04 | 2.4674531E−04 |
| A5 | 2.6883232E−04 | 5.8061799E−05 |
| A6 | −6.8461300E−05 | 2.3318454E−05 |
| A7 | −1.0880951E−05 | −1.1045181E−05 |
| A8 | 4.0399249E−06 | −1.4081052E−06 |
| A9 | 2.4638223E−07 | 7.7223797E−07 |
| A10 | −1.2929394E−07 | 2.5735188E−08 |
| A11 | −3.1453878E−09 | −2.5796972E−08 |
| A12 | 2.7224982E−09 | 1.3584844E−10 |
| A13 | 1.0874429E−11 | 4.7609295E−10 |
| A14 | −4.0691470E−11 | −1.1651921E−11 |
| A15 | 3.2911318E−13 | −4.9926000E−12 |
| A16 | 4.1999308E−13 | 1.7183120E−13 |
| A17 | −5.0040903E−15 | 2.7966422E−14 |
| A18 | −2.6200751E−15 | −1.0872754E−15 |
| A19 | 2.1933497E−17 | −6.5200616E−17 |
| A20 | 7.2515032E−18 | 2.5816961E−18 |

### Example 6

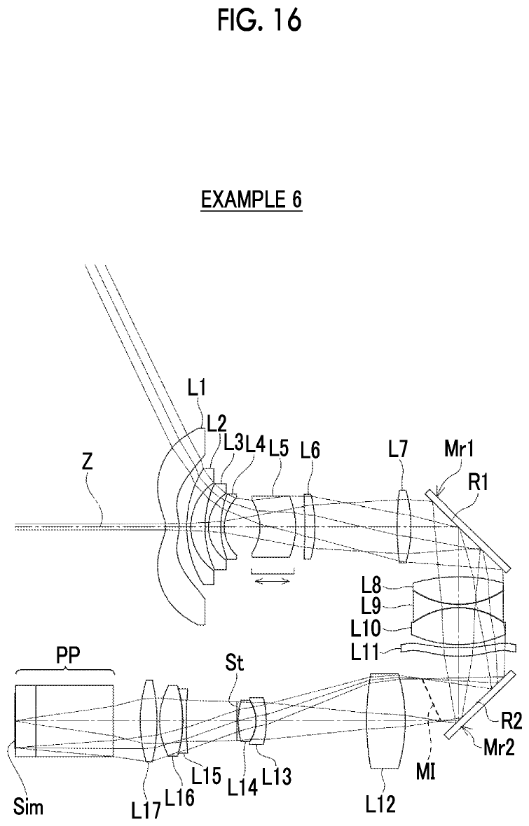

FIG. 16 shows a cross-sectional view of a configuration and luminous flux of a projection optical system of Example 6. The projection optical system of Example 6 includes, in order from the magnification side to the reduction side along the optical path, lenses L1 to L7, reflection mirror Mr1, lenses L8 to L11, a reflection mirror Mr2, lenses L12 to L14, an aperture stop St, and lenses L15 to L17. The reflection mirror Mr1 and the reflection mirror Mr2 respectively have a reflecting surface R1 and a reflecting surface R2. The reflecting surface R1 and the reflecting surface R2 are surfaces having no power, and each of the reflecting surface R1 and the reflecting surface R2 functions as an optical path deflection surface that deflects the optical path by 90 degrees. The intermediate image MI near the optical axis is formed between the reflection mirror Mr2 and the lens L12. The focusing group consists of the lens L5.

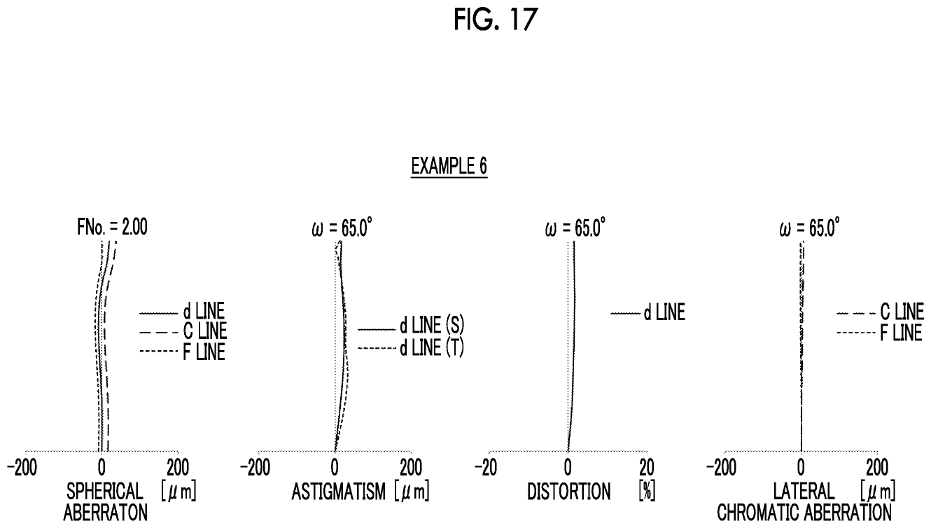

Regarding the projection optical system of Example 6, Table 21 shows basic lens data, Table 22 shows specifications, Table 23 shows variable surface spacings, Table 24 shows aspherical coefficients thereof, and FIG. 17 shows aberration diagrams. The aberration diagrams are in a state where the projection distance is 0.279 m (meters).

TABLE 21
Example 6

| Sn | r | d | nd | γd |
|---|---|---|---|---|
| *1 | −3.1042 | 2.0000 | 1.53158 | 55.08 |
| *2 | −4.9904 | 1.1202 | | |
| 3 | 16.9729 | 0.6000 | 1.80420 | 46.50 |
| 4 | 8.2687 | 2.1019 | | |
| 5 | 15.6152 | 0.5200 | 1.83481 | 42.72 |
| 6 | 6.2507 | 1.8185 | | |
| 7 | 13.4058 | 0.5200 | 1.83481 | 42.72 |
| 8 | 6.1342 | DD[8] | | |
| 9 | −7.4459 | 5.2194 | 1.48749 | 70.44 |
| 10 | −12.2000 | DD[10] | | |
| 11 | −139.0858 | 1.5211 | 1.80518 | 25.46 |
| 12 | −19.4323 | 12.2047 | | |
| 13 | 47.1498 | 2.0584 | 1.48749 | 70.44 |
| 14 | −20.1123 | 7.0116 | | |
| 15(R1) | ∞ | 7.6195 | | |
| 16 | 23.6191 | 4.2242 | 1.65160 | 58.54 |
| 17 | −11.5363 | 0.5200 | 1.84666 | 23.78 |
| 18 | 10.9887 | 5.6320 | 1.59282 | 68.62 |
| 19 | −16.3340 | 0.4991 | | |
| *20 | −27.8027 | 1.3000 | 1.51007 | 56.24 |
| *21 | −17.0997 | 9.9089 | | |
| 22(R2) | ∞ | 7.8848 | | |
| 23 | 25.9270 | 5.7087 | 1.92286 | 20.88 |
| 24 | −43.7883 | 14.8380 | | |
| 25 | 15.0977 | 1.5009 | 1.92286 | 20.88 |
| 26 | 5.9271 | 0.0272 | | |
| 27 | 5.8926 | 2.6124 | 1.49700 | 81.54 |
| 28 | −12.4106 | 0.1991 | | |
| 29(St) | ∞ | 7.4969 | | |
| 30 | −58.2598 | 0.5191 | 1.90366 | 31.31 |
| 31 | 18.7887 | 0.0292 | | |
| 32 | 19.4593 | 3.4046 | 1.49700 | 81.54 |
| 33 | −11.7989 | 0.3992 | | |
| 34 | 29.0187 | 2.4628 | 1.92286 | 20.88 |
| 35 | −23.2056 | 4.0942 | | |
| 36 | ∞ | 11.5000 | 1.67003 | 47.20 |
| 37 | ∞ | 3.0000 | 1.48749 | 70.44 |
| 38 | ∞ | | | |

TABLE 22
Example 6

| | |
|---|---|
| \|f\| | 1.87 |
| Bf | 12.98 |
| FNo. | 2.00 |
| 2ω[°] | 130.0 |
| Imax | 4.12 |
| DL | 5.95 |

TABLE 23
Example 6

| Projection distance | 0.279 m | 0.200 m | 0.570 m |
|---|---|---|---|
| DD[8] | 5.27 | 5.11 | 5.47 |
| DD[10] | 1.35 | 1.51 | 1.16 |

TABLE 24
Example 6

| Sn | 1 | 2 | 20 | 21 |
|---|---|---|---|---|
| KA | −2.6702442E+00 | −4.9999915E+00 | 8.5729145E−06 | −5.0000083E+00 |
| A3 | 1.2156820E−02 | 9.2572567E−03 | 0.0000000E+00 | 0.0000000E+00 |
| A4 | −1.1834866E−03 | 1.9758909E−03 | −4.5871017E−04 | −3.1743254E−04 |
| A5 | 9.1446504E−05 | −2.4760050E−04 | 2.2974253E−04 | 1.0769405E−04 |
| A6 | 1.6395248E−06 | −7.7718019E−05 | −5.6226455E−05 | −3.2625021E−06 |
| A7 | −6.5379047E−06 | 1.3469108E−05 | 8.8604609E−07 | −8.9147473E−06 |
| A8 | 1.2224325E−06 | 7.1926034E−07 | 2.0122113E−06 | 1.9245530E−06 |
| A9 | 3.9602062E−09 | −2.4277594E−07 | −2.0658137E−07 | 1.2834428E−07 |
| A10 | −2.0235316E−08 | −2.5492954E−10 | −2.0513404E−08 | −5.9137047E−08 |
| A11 | 1.2484023E−09 | 2.4421384E−09 | 3.9396178E−09 | 8.1915616E−10 |
| A12 | 1.2805691E−10 | −6.0707450E−11 | 2.3023283E−11 | 8.5238777E−10 |
| A13 | −1.4584400E−11 | −1.4010703E−11 | −3.4558414E−11 | −3.7559196E−11 |
| A14 | −2.4296295E−13 | 5.5250415E−13 | 9.4538230E−13 | −6.9265741E−12 |
| A15 | 7.3530865E−14 | 4.5776482E−14 | 1.6055639E−13 | 3.6526216E−13 |
| A16 | −9.3157209E−16 | −2.2310078E−15 | −6.8742650E−15 | 3.2804323E−14 |
| A17 | −1.7815303E−16 | −7.9402795E−17 | −3.8248555E−16 | −1.5070497E−15 |
| A18 | 4.9532053E−18 | 4.3964873E−18 | 1.9315186E−17 | −8.5253187E−17 |
| A19 | 1.6957184E−19 | 5.6667683E−20 | 3.6799041E−19 | 2.3111904E−18 |
| A20 | −6.3112819E−21 | −3.4337244E−21 | −1.9941538E−20 | 9.4633625E−20 |

Regarding the projection optical systems of Examples 1 to 6, Table 25 shows corresponding values of Conditional Expressions (1) to (8), β used for calculating the corresponding value of Conditional Expression (6), and values of Ymax at the respective values of β.

TABLE 25

| Expression | | Example | Example | Example | Example | Example | Example |
|---|---|---|---|---|---|---|---|
| Number | | 1 | 2 | 3 | 4 | 5 | 6 |
| (1) | ΣTHe | 57.8 | 46.9 | 58.5 | 47.2 | 48.9 | 40.3 |
| (2) | Imax/\|f\| | 3.09 | 2.10 | 2.55 | 3.03 | 2.40 | 2.20 |
| (3) | d1 | 37.8 | 35.2 | 18.9 | 29.3 | 25.3 | 29.7 |
| (4) | d2 | 47.9 | 63.0 | 42.5 | 38.8 | 44.0 | 47.1 |
| (5) | Imax/DL | 0.708 | 0.661 | 0.681 | 0.773 | 0.773 | 0.692 |
| (6) | (Imax-β × Ymax)/ | −0.010 | 0.015 | 0.016 | −0.010 | −0.010 | 0.014 |
| | (β × Ymax) | | | | | | |
| (7) | ΣTH18/ΣTHpw | 0.333 | 0.280 | 0.380 | 0.290 | 0.365 | 0.344 |
| (8) | DifE/Imax | −0.590 | −0.284 | 1.005 | −1.073 | −0.683 | −0.804 |

| | | | | | | |
|---|---|---|---|---|---|---|
| β | 0.00747 | 0.00932 | 0.00659 | 0.0069 | 0.00669 | 0.00658 |
| Ymax | 810.690 | 592.515 | 605.217 | 673.430 | 694.298 | 616.754 |

The projection optical systems of Examples 1 to 6 each have a wide angle of view which is a total angle of view of 120 degrees or more at the wide angle end. The projection optical systems of Examples 1 to 6 each have a small F number which is an F number of 2.1 or less. Further, while the projection optical system of Examples 1 to 6 are configured to have a small size, the projection optical system implements high optical performance by satisfactorily correcting various aberrations.

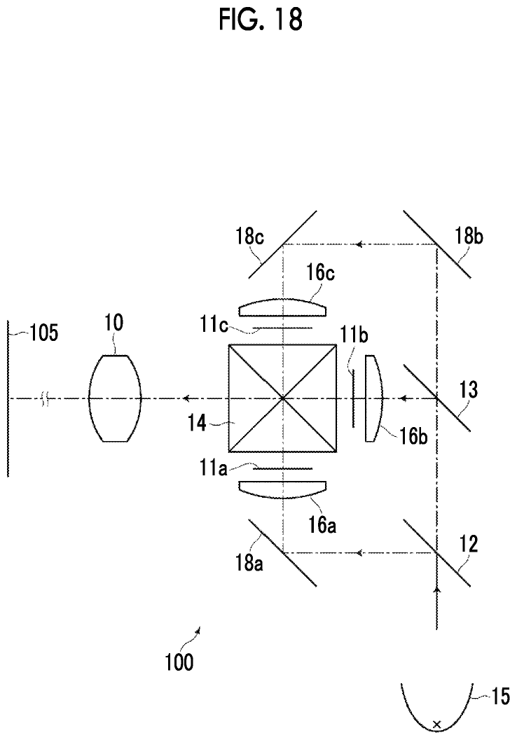

Next, a projection type display device according to an embodiment of the present disclosure will be described. FIG. 18 is a schematic configuration diagram of a projection type display device according to an embodiment of the present disclosure. The projection type display device 100 shown in FIG. 18 has a projection optical system 10 according to an embodiment of the present disclosure, a light source 15, and transmissive display elements 11a to 11c as light valves corresponding to each color light and outputting an optical image. Further, the projection type display device 100 has dichroic mirrors 12 and 13 for color separation, cross dichroic prisms 14 for color synthesis, condenser lenses 16a to 16c, and total reflection mirrors 18a to 18c for deflecting the optical path. It should be noted that, FIG. 18 schematically shows the projection optical system 10. Furthermore, an integrator is disposed between the light source 15 and the dichroic mirror 12, but is not shown in FIG. 18.

White light originating from the light source 15 is separated into ray with three colors (green light, blue light, and red light) through the dichroic mirrors 12 and 13. Thereafter, the ray respectively pass through the condenser lenses 16a to 16c, are incident into and modulated through the transmissive display elements 11a to 11c respectively corresponding to the ray with the respective colors, are subjected to color synthesis through the cross dichroic prism 14, and are subsequently incident into the projection optical system 10. The projection optical system 10 projects an optical image, which is based on the modulated light modulated through the transmissive display elements 11a to 11c, onto a screen 105.

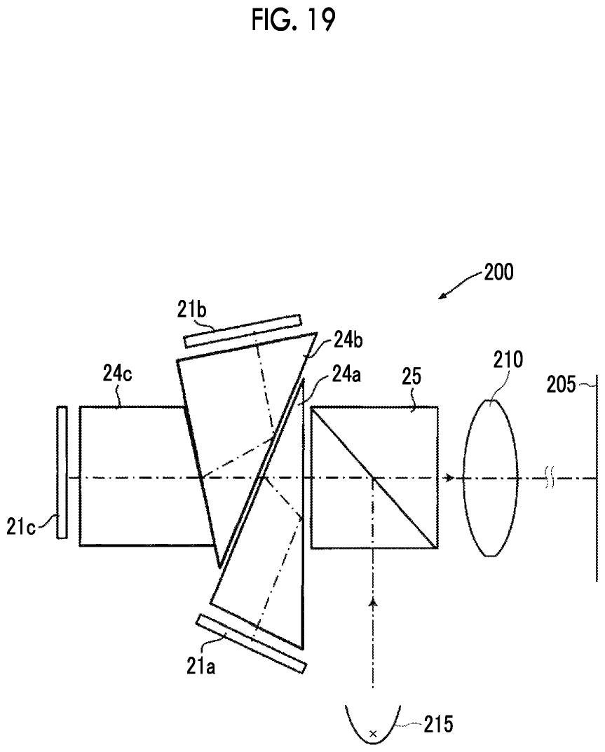

FIG. 19 is a schematic configuration diagram of a projection type display device according to another embodiment of the present disclosure. The projection type display device 200 shown in FIG. 19 has a projection optical system 210 according to an embodiment of the present disclosure, a light source 215, and digital micromirror device (DMD: registered trademark) elements 21a to 21c as light valves each of which outputs an optical image corresponding to each color light. Further, the projection type display device 200 has total internal reflection (TIR) prisms 24a to 24c for color separation and color synthesis, and a polarized light separating prism 25 that separates illumination light and projection light. It should be noted that FIG. 19 schematically shows the projection optical system 210. Furthermore, an integrator is disposed between the light source 215 and the polarized light separating prism 25, but is not shown in FIG. 19.

White light originating from the light source 215 is reflected on a reflecting surface inside the polarized light separating prism 25, and is separated into ray with three colors (green light, blue light, and red light) through the TIR prisms 24a to 24c. The separated ray with the respective colors are respectively incident into and modulated through the corresponding DMD elements 21a to 21c, travel through the TIR prisms 24a to 24c again in a reverse direction, are subjected to color synthesis, are subsequently transmitted through the polarized light separating prism 25, and are incident into the projection optical system 210. The projection optical system 210 projects an optical image, which is based on the modulated light modulated through the DMD elements 21a to 21c, onto a screen 205.

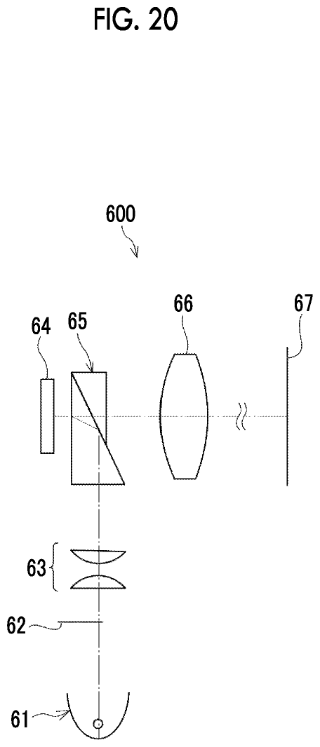

FIG. 20 is a schematic configuration diagram of a projection type display device according to still another embodiment of the present disclosure. The projection type display device 600 shown in FIG. 20 has a projection optical system 66 according to an embodiment of the present disclosure, a light source 61, and a DMD element 64 as a light valve that corresponds to each color light and that outputs an optical image. Further, the projection type display device 600 has a color wheel 62, a light guide optical system 63, and a TIR prism 65. It should be noted that, FIG. 20 schematically shows the projection optical system 66.

Filters having three colors of green, blue, and red are provided on a circumference of the color wheel 62. In a case where the color wheel 62 is rotated, the filters having the respective colors are sequentially inserted on the optical path. White light originating from the light source 61 is incident on the rotating color wheel 62 and is time-divided into luminous fluxes having three colors (green light, blue light, and red light). The luminous fluxes having the respective colors after the time-division passes through the light guide optical system 63 and the TIR prism 65, are incident into the DMD elements 64 to be modulated, and are incident into the projection optical system 66 through the TIR prism 65 again. The projection optical system 66 projects an optical image, which is based on the modulated light modulated through the DMD element 64, onto a screen 67.

The technique of the present disclosure has been hitherto described through embodiments and examples, but the technique of the present disclosure is not limited to the above-mentioned embodiments and examples, and may be modified into various forms. For example, values such as the curvature radius, the surface spacing, the refractive index, the Abbe number, and the aspherical coefficient of each lens are not limited to the values shown in the examples, and different values may be used therefor.

Further, the projection type display device according to the technique of the present disclosure is not limited to the above-mentioned configuration, and may be modified into various forms such as the optical member used for ray separation or ray synthesis and the light valve. The light valve is not limited to a form in which light from a light source is spatially modulated through an image display element and is output as an optical image based on image data, but may be a form in which light itself output from the self-light-emitting image display element is output as an optical image based on the image data. Examples of the self-light-emitting image display element include an image display element in which light emitting elements such as light emitting diodes (LED) or organic light emitting diodes (OLED) are two-dimensionally arranged. The light valve is not limited to the three-plate type, and may be a single-plate type. By adopting a configuration in which the light valve corresponds to the single-plate type, it is possible to achieve reduction in size of the optical engine.

Regarding the above-mentioned embodiments and examples, the following Supplementary Notes will be further disclosed.

### Supplementary Note 1

A projection optical system that projects an image, which is displayed on a display surface of a display element on a reduction side, onto a projection surface on a magnification side,
in which the projection optical system does not include a reflecting surface having a power,
the projection optical system includes at least one optical path deflection surface, which deflects an optical path by 90 degrees, in the optical path of the projection optical system, and
assuming that
   a sum of thicknesses of all optical elements on an optical axis included in a range from a lens surface closest to the magnification side in the projection optical system to a lens surface closest to the reduction side in the projection optical system is ΣTHe,
   a height of a maximum effective ray on the display surface from the optical axis is Imax, and
   a focal length of the projection optical system is f,
   where f is a value at a wide angle end in a case where the projection optical system is a variable magnification optical system, and
   mm is a unit of length,
   Conditional Expressions (1) and (2) are satisfied, which are represented by

$$\sum THe < 70 mm , \qquad ( 1 )$$

$$and$$

$$1.7 < I max \text{/\textbar} f \vert . \qquad ( 2 )$$

### Supplementary Note 2

The projection optical system according to Supplementary Note 1,
in which the projection optical system includes only two optical path deflection surfaces in the optical path of the projection optical system, and
assuming that
   a distance on the optical axis from the optical path deflection surface on the magnification side to the optical path deflection surface on the reduction side is d1, and
   a distance on the optical axis from the optical path deflection surface on the reduction side to the lens surface closest to the reduction side in the projection optical system is d2,
   where d1 and d2 are values at the wide angle end in a case where the projection optical system is a variable magnification optical system,
   Conditional Expressions (3) and (4) are satisfied, which are represented by

$$d 1 < 70 mm , \qquad ( 3 )$$

$$and$$

$$d 2 < 10 \; 0 mm . \qquad ( 4 )$$

### Supplementary Note 3

The projection optical system according to Supplementary Note 1 or 2,
in which assuming that a longest diameter of a maximum region capable of display of the image in the display element is DL, Conditional Expression (5) is satisfied, which is represented by

$$I max / DL < 0 \text{.78} . \qquad ( 5 )$$

### Supplementary Note 4

The projection optical system according to any one of Supplementary Notes 1 to 3,
in which assuming that
   a height of a maximum effective ray on the projection surface from the optical axis is Ymax, and
   a paraxial image magnification of the projection optical system in a case where the magnification side is an object side and the reduction side is an image side is β,
   where β is a value at a wide angle end in a case where the projection optical system is a variable magnification optical system,
   Conditional Expression (6) is satisfied, which is represented by

$$- 0.05 < ( I max - β \times Y max ) / ( β \times Y max ) < 0 \text{.05} . \qquad ( 6 )$$

### Supplementary Note 5

The projection optical system according to any one of Supplementary Notes 1 to 4,
in which assuming that
   a sum of thicknesses of all optical elements on the optical axis, which have powers and are included in the range from the lens surface closest to the magnification side in the projection optical system to the lens surface closest to the reduction side in the projection optical system, is ΣTHpw, and
   a sum of thicknesses of all optical elements, which have a refractive index of 1.8 or more at a d line, on the optical axis among the optical elements, which have the powers and are included in the range from the lens surface closest to the magnification side in the projection optical system to the lens surface closest to the reduction side in the projection optical system, is ΣTH18,
   Conditional Expression (7) is satisfied, which is represented by

$$0.27 < \sum TH 18 / \sum THpw < 0.5 . \qquad ( 7 )$$

### Supplementary Note 6

The projection optical system according to any one of Supplementary Notes 1 to 5, in which an intermediate image is formed on an inside of the projection optical system.

### Supplementary Note 7

The projection optical system according to Supplementary Note 6,
in which the projection optical system includes only two optical path deflection surfaces in the optical path of the projection optical system, and
the intermediate image is formed on the optical path between the optical path deflection surface on the magnification side and a surface adjacent to the reduction side of the optical path deflection surface on the reduction side.

### Supplementary Note 8

The projection optical system according to Supplementary Note 6 or 7,
further comprising an aperture stop at a position closer to the reduction side than the intermediate image,
in which a real image of the aperture stop is present on an inside of the projection optical system closer to the magnification side than the intermediate image, and
assuming that
   a position, at which a ray that is emitted from an outermost circumference of an effective image circle on the reduction side and that has passed through a center of the aperture stop toward the magnification side intersects with the optical axis at a position closer to the magnification side than the intermediate image, is Enp(Imax),
   a position of a paraxial image of the aperture stop is Enp(0), and
   an air-equivalent distance on the optical axis from Enp(0) to Enp(Imax) is DifE,
   where a sign of DifE is positive in a case where the air-equivalent distance is a distance on the reduction side, and the sign is negative in a case where the air-equivalent distance is a distance on the magnification side, with reference to Enp(0), and
   DifE is a value at a wide angle end in a case where the projection optical system is a variable magnification optical system,
   Conditional Expression (8) is satisfied, which is represented by

$$- 3 < DifE / I max < - 0.2 . \qquad ( 8 )$$

### Supplementary Note 9

The projection optical system according to any one of Supplementary Notes 1 to 8,
in which a lens closest to the magnification side has a shape in which a part of a rotationally symmetric shape is absent.

### Supplementary Note 10

The projection optical system according to Supplementary Note 2 or 7,
in which at least one of the optical path deflection surfaces is a surface of a reflection mirror.

### Supplementary Note 11

The projection optical system according to Supplementary Note 2 or 7,
in which at least one of the optical path deflection surfaces is a surface of a prism.

### Supplementary Note 12

The projection optical system according to any one of Supplementary Notes 1 to 11,
in which Conditional Expression (1-1) is satisfied, which is represented by

$$30 mm < \sum THe < 70 mm . \qquad ( 1 - 1 )$$

### Supplementary Note 13

The projection optical system according to any one of Supplementary Notes 1 to 12,
in which Conditional Expression (2-1) is satisfied, which is represented by

$$2 < I max \text{/\textbar} f \vert < 35. \qquad ( 2 - 1 )$$

### Supplementary Note 14

The projection optical system according to Supplementary Note 2,
in which Conditional Expression (3-1) is satisfied, which is represented by

$$10 mm < d 1 < 50 mm . \qquad ( 3 - 1 )$$

### Supplementary Note 15

The projection optical system according to Supplementary Note 2,
in which Conditional Expression (4-1) is satisfied, which is represented by

$$20 mm < d 2 < 75 mm . \qquad ( 4 - 1 )$$

### Supplementary Note 16

The projection optical system according to Supplementary Note 3,
in which Conditional Expression (5-1) is satisfied, which is represented by

$$0.65 < I max / DL < 0 \text{.72} . \qquad ( 5 - 1 )$$

### Supplementary Note 17

The projection optical system according to Supplementary Note 4,
in which Conditional Expression (6-1) is satisfied, which is represented by

$$- 0.03 < ( I max - β \times Y max ) / ( β \times Ymax ) < 0 \text{.03} . \qquad ( 6 - 1 )$$

### Supplementary Note 18

The projection optical system according to Supplementary Note 5,
in which Conditional Expression (7-1) is satisfied, which is represented by

$$0 \text{.3} < \sum TH 18 / \sum THpw < 0.4 . \qquad ( 7 - 1 )$$

### Supplementary Note 19

The projection optical system according to Supplementary Note 8,
in which Conditional Expression (8-1) is satisfied, which is represented by

$$- 2.5 < DifE / I max < - 0.5 . \qquad ( 8.1 )$$

### Supplementary Note 20

A projection type display device comprising the projection optical system according to any one of Supplementary Notes 1 to 19.

What is claimed is:

1. A projection optical system that projects an image, which is displayed on a display surface of a display element on a reduction side, onto a projection surface on a magnification side,
wherein the projection optical system does not include a reflecting surface having a power,
the projection optical system includes at least one optical path deflection surface, which deflects an optical path by 90 degrees, in the optical path of the projection optical system, and
assuming that
a sum of thicknesses of all optical elements on an optical axis included in a range from a lens surface closest to the magnification side in the projection optical system to a lens surface closest to the reduction side in the projection optical system is ΣTHe,
a height of a maximum effective ray on the display surface from the optical axis is Imax, and
a focal length of the projection optical system is f,
where f is a value at a wide angle end in a case where the projection optical system is a variable magnification optical system, and
mm is a unit of length,
Conditional Expressions (1) and (2) are satisfied, which are represented by
$$\sum THe < 70 mm , \qquad ( 1 )$$
$$and$$
$$1.7 < I max / \vert f \vert . \qquad ( 2 )$$

2. The projection optical system according to claim 1,
wherein the projection optical system includes only two optical path deflection surfaces in the optical path of the projection optical system, and
assuming that
a distance on the optical axis from the optical path deflection surface on the magnification side to the optical path deflection surface on the reduction side is d1, and
a distance on the optical axis from the optical path deflection surface on the reduction side to the lens surface closest to the reduction side in the projection optical system is d2,
where d1 and d2 are values at the wide angle end in a case where the projection optical system is a variable magnification optical system,
Conditional Expressions (3) and (4) are satisfied, which are represented by
$$d 1 < 70 mm , \qquad ( 3 )$$
$$and$$
$$d 2 < 100 mm . \qquad ( 4 )$$

3. The projection optical system according to claim 1,
wherein assuming that a longest diameter of a maximum region capable of display of the image in the display element is DL, Conditional Expression (5) is satisfied, which is represented by
$$I max / DL < 0 \text{.78} . \qquad ( 5 )$$

4. The projection optical system according to claim 1,
wherein assuming that
a height of a maximum effective ray on the projection surface from the optical axis is Ymax, and
a paraxial image magnification of the projection optical system in a case where the magnification side is an object side and the reduction side is an image side is β,
where β is a value at a wide angle end in a case where the projection optical system is a variable magnification optical system,
Conditional Expression (6) is satisfied, which is represented by
$$- 0.05 < ( I max - β \times Y max ) / ( β \times Y max ) < 0 \text{.05} . \qquad ( 6 )$$

5. The projection optical system according to claim 1,
wherein assuming that
a sum of thicknesses of all optical elements on the optical axis, which have powers and are included in the range from the lens surface closest to the magnification side in the projection optical system to the lens surface closest to the reduction side in the projection optical system, is ΣTHpw, and
a sum of thicknesses of all optical elements, which have a refractive index of 1.8 or more at a d line, on the optical axis among the optical elements, which have the powers and are included in the range from the lens surface closest to the magnification side in the projection optical system to the lens surface closest to the reduction side in the projection optical system, is ΣTH18,
Conditional Expression (7) is satisfied, which is represented by
$$0.27 < \sum TH 18 / \sum THpw < 0.5 . \qquad ( 7 )$$

6. The projection optical system according to claim 1,
wherein an intermediate image is formed on an inside of the projection optical system.

7. The projection optical system according to claim 6,
wherein the projection optical system includes only two optical path deflection surfaces in the optical path of the projection optical system, and
the intermediate image is formed on the optical path between the optical path deflection surface on the magnification side and a surface adjacent to the reduction side of the optical path deflection surface on the reduction side.

8. The projection optical system according to claim 6, further comprising:
an aperture stop at a position closer to the reduction side than the intermediate image,
wherein a real image of the aperture stop is present on an inside of the projection optical system closer to the magnification side than the intermediate image, and
assuming that
a position, at which a ray that is emitted from an outermost circumference of an effective image circle on the reduction side and that has passed through a center of the aperture stop toward the magnification side intersects with the optical axis at a position closer to the magnification side than the intermediate image, is Enp(Imax),
a position of a paraxial image of the aperture stop is Enp(0), and
an air-equivalent distance on the optical axis from Enp(0) to Enp(Imax) is DifE,
where a sign of DifE is positive in a case where the air-equivalent distance is a distance on the reduction side, and the sign is negative in a case where the air-equivalent distance is a distance on the magnification side, with reference to Enp(0), and
DifE is a value at a wide angle end in a case where the projection optical system is a variable magnification optical system,
Conditional Expression (8) is satisfied, which is represented by
$$- 3 < DifE / I max < - 0.2 . \qquad ( 8 )$$

9. The projection optical system according to claim 1,
wherein a lens closest to the magnification side has a shape in which a part of a rotationally symmetric shape is absent.

10. The projection optical system according to claim 2,
wherein at least one of the optical path deflection surfaces is a surface of a reflection mirror.

11. The projection optical system according to claim 2,
wherein at least one of the optical path deflection surfaces is a surface of a prism.

12. The projection optical system according to claim 1, wherein Conditional Expression (1-1) is satisfied, which is represented by
$$30 mm < \sum THe < 70 mm . \qquad ( 1.1 )$$

13. The projection optical system according to claim 1, wherein Conditional Expression (2-1) is satisfied, which is represented by
$$2 < I max / \vert f \vert < 3.5 . \qquad ( 2.1 )$$

14. The projection optical system according to claim 2, wherein Conditional Expression (3-1) is satisfied, which is represented by
$$10 mm < d 1 < 50 mm . \qquad ( 3.1 )$$

15. The projection optical system according to claim 2, wherein Conditional Expression (4-1) is satisfied, which is represented by
$$20 mm < d 2 < 75 mm . \qquad ( 4.1 )$$

16. The projection optical system according to claim 3, wherein Conditional Expression (5-1) is satisfied, which is represented by
$$0.65 < I max / DL < 0 \text{.72} . \qquad ( 5.1 )$$

17. The projection optical system according to claim 4, wherein Conditional Expression (6-1) is satisfied, which is represented by
$$- 0.03 < ( I max - β \times Y max ) / ( β \times Y max ) < 0 \text{.03} . \qquad ( 6.1 )$$

18. The projection optical system according to claim 5, wherein Conditional Expression (7-1) is satisfied, which is represented by
$$0 \text{.3} < \sum TH 18 / \sum THpw < 0.4 . \qquad ( 7.1 )$$

19. The projection optical system according to claim 8, wherein Conditional Expression (8-1) is satisfied, which is represented by
$$- 2.5 < DifE / I max < - 0.5 . \qquad ( 8.1 )$$

20. A projection type display device comprising:
the projection optical system according to claim 1.
